(19) United States
(12) Patent Application Publication
(10) Pub. No.: US 2008/0247413 A1
(43) Pub. Date: Oct. 9, 2008

(54) COMMUNICATION APPARATUS AND COMMUNICATION METHOD

(75) Inventor: Natsushi ONO, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/098,628

(22) Filed: Apr. 7, 2008

(30) Foreign Application Priority Data
Apr. 9, 2007 (JP) P2007-101534

(51) Int. Cl. H04J 3/26

(52) U.S. Cl. 370/432

(57) ABSTRACT

A communication apparatus includes: a storage section that stores a packet; a copy section that creates one or more copies of the packet stored in the storage section; and a transmission section that transmits at least two among the copies created by the copy section and the packet stored in the storage section in a plurality of frames.

### BACKGROUND

1. Field of the Invention

The present invention relates to a communication apparatus and a communication method that transmit a packet by wire or wireless.

2. Description of the Prior Art

In recent years, IP telephones using a VoIP technique are being distributed. The IP telephones are characterized in that telephone call costs are cheap since a voice is transmitted and received through the Internet or a dedicated network by packetizing the voice, and has recently been used in many homes as well as companies since a major Internet service provider provides services in various regions. Moreover, there has recently been a movement to make cordless IP telephone devices. For example, a product in which a master unit terminates an IP telephone protocol and exchanges a voice with a slave unit in a conventional wireless telephone system between the master unit and the slave unit is also released. On the contrary, a cordless telephone device based on a wireless LAN in which the IP telephone protocol may be terminated in the slave unit instead of being terminated in the master unit, the slave unit may be taken out to a public wireless access point such as a hot spot or the like, and a telephone call may be inexpensively made is also proposed.

A conventional wireless LAN telephone will be described with reference to the drawing.

FIG. 38 is a view showing a transmission aspect of a voice packet from a master unit to a slave unit at the time of a telephone call in the conventional wireless LAN telephone. In the conventional wireless LAN telephone, voice packets are one-to-one mapped to radio frames, and error recovery is performed by retransmitting a radio frame when an error occurs (for example, see JP-A-2002-247647).

The above-described conventional configuration has a problem in that a retransmission should be performed whenever an error occurs, a large delay is caused due to retransmission repetition, and communication quality is degraded.

### SUMMARY

The present invention has been made in view of the above situation, and an object of the invention is to provide a communication apparatus and a communication method in which high-quality communication having a small delay is possible.

According to the present invention, there is provided a communication apparatus including: a storage section that stores a packet; a copy section that creates one or more copies of the packet stored in the storage section; and a transmission section that transmits at least two among the one or more copies and the packet in plural frames.

According to this configuration, a communication apparatus and a communication method can be provided in which the number of retransmissions can be reduced and high-quality communication having a small delay is possible since the same packets are included in separate frames even when an error occurs in one frame by transmitting the same packet in the other frame.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a functional block diagram of a slave unit in a first embodiment of the present invention;

FIG. 2 is a circuit block diagram of the slave unit in the first embodiment of the present invention;

FIG. 3 is a functional block diagram of a master unit in the first embodiment of the present invention;

FIG. 4 is a circuit block diagram of the master unit in the first embodiment of the present invention;

FIG. 5 is an overall configuration diagram of a system in the first embodiment of the present invention;

FIG. 6 is a sequence diagram showing an overall process flow in the first embodiment of the present invention;

FIG. 7 is a task configuration diagram of the slave unit in the first embodiment of the present invention;

FIG. 8 is a task configuration diagram of the master unit in the first embodiment of the present invention;

FIG. 9 is a flowchart of an encode task of the slave unit in the first embodiment of the present invention;

FIG. 10 is a flowchart of a decode task of the slave unit in the first embodiment of the present invention;

FIG. 11 is a state transition diagram of a call control task of the slave unit in the first embodiment of the present invention;

FIG. 12 is a flowchart of a protocol processing task of the slave unit in the first embodiment of the present invention;

FIG. 13 is a flowchart of a radio transmission task in the first embodiment of the present invention;

FIG. 14 is a flowchart of a merge process in the first embodiment of the present invention;

FIG. 15 is a configuration diagram of a radio frame in a wireless LAN telephone;

FIG. 16 is a configuration diagram of a radio frame in the first embodiment of the present invention;

FIG. 17 is a flowchart of a radio reception task in the first embodiment of the present invention;

FIG. 18 is a flowchart of a bridge task of the master unit in the first embodiment of the present invention;

FIG. 19 is a view showing the relationship of a voice packet and a radio frame in the first embodiment of the present invention;

FIG. 20 is a view showing the relationship of an error and a voice packet in the first embodiment of the present invention;

FIG. 21 is a functional block diagram of a slave unit in a second embodiment of the present invention;

FIG. 22 is a functional block diagram of a master unit in the second embodiment of the present invention;

FIG. 23 is a task configuration diagram of the slave unit in the second embodiment of the present invention;

FIG. 24 is a flowchart of a measurement task of the slave unit in the second embodiment of the present invention;

FIG. 25 is a flowchart of a transmission task of the slave unit in the second embodiment of the present invention;

FIG. 26 is a relationship diagram between a total delay amount and a total delay allowance time in the second embodiment of the present invention;

FIG. 27 is a view showing a content example of a transmission packet queue in the second embodiment of the present invention;

FIG. 28 is a flowchart of a merge process of the slave unit in the second embodiment of the present invention;

FIG. 29 is a configuration diagram of a radio frame in the second embodiment of the present invention;

FIG. 30 is a flowchart of a reception task in the second embodiment of the present invention;

FIG. 31 is a flowchart of a transmission task of the master unit in the second embodiment of the present invention;

FIG. 32 is a functional block diagram of a slave unit in an third embodiment of the present invention;

FIG. 33 is a functional block diagram of a master unit in the third embodiment of the present invention;

FIG. 34 is a flowchart of a transmission task of the slave unit in the third embodiment of the present invention;

FIG. 35 is a flowchart of a reception task in the third embodiment of the present invention;

FIG. 36 is a flowchart of a redundant packet search process in the third embodiment of the present invention;

FIG. 37 is a flowchart of a transmission task of the master unit in the third embodiment of the present invention; and

FIG. 38 is a view of a transmission/reception aspect of a radio frame in a conventional wireless LAN telephone device.

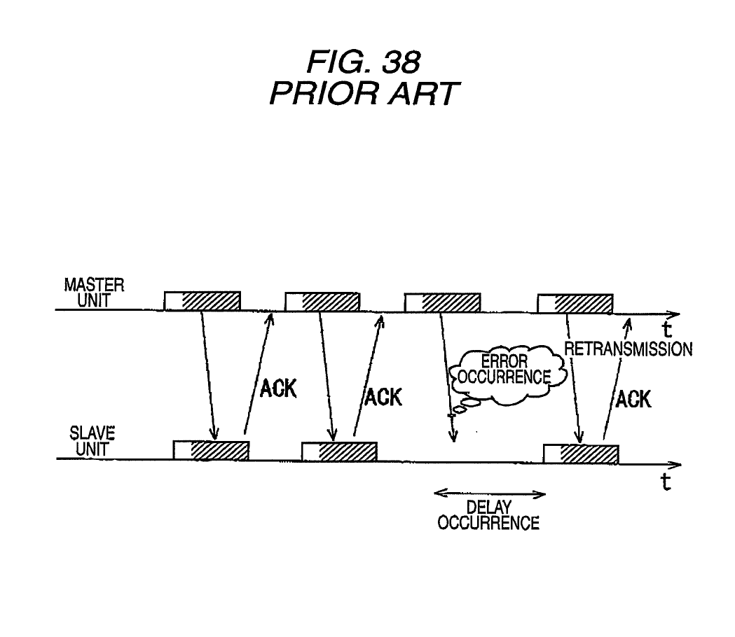

### DETAILED DESCRIPTION

Hereinafter, embodiments of the present invention will be described with reference to the drawings.

### First Embodiment

First, a slave unit of a wireless LAN telephone device will be described.

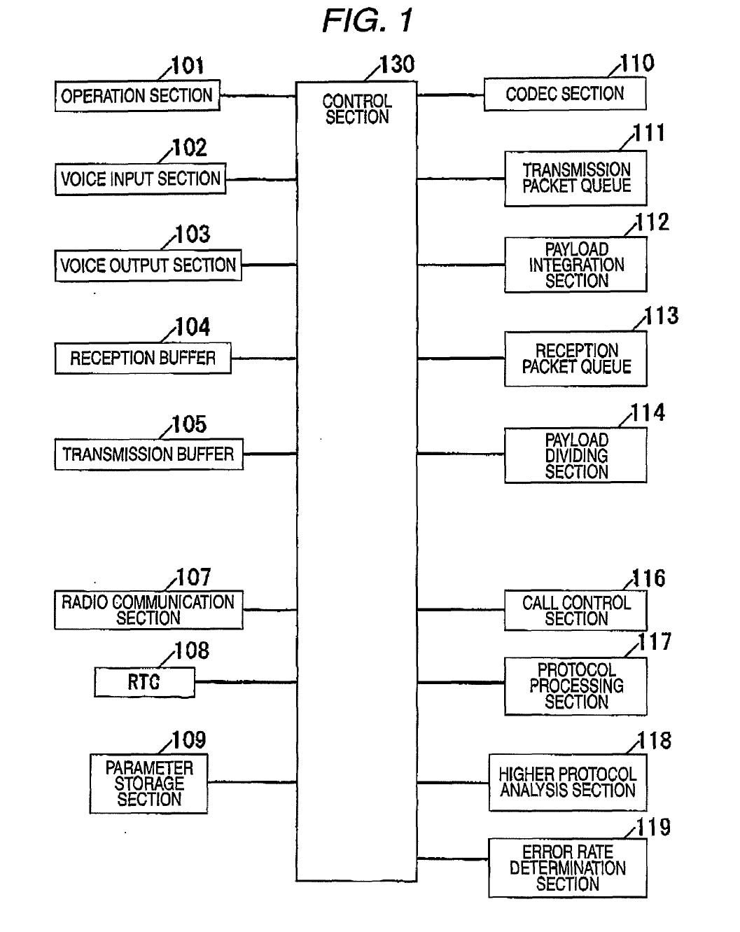

FIG. 1 is a functional block diagram showing the slave unit of the wireless LAN telephone device in a first embodiment of the present invention.

In FIG. 1, reference numeral 101 is an operation section for designating an outgoing call destination and making a telephone call instruction at the time of an incoming call and a call end instruction, 102 is a voice input section for inputting a voice, 103 is a voice output section for outputting a voice, 104 is a reception buffer for accumulating data extracted from a received radio frame, 105 is a transmission buffer for accumulating radio transmission data, 107 is a radio communication section for radio framing and transmitting the data accumulated in the transmission buffer 105 and receiving a radio frame to store frame content in the reception buffer 104, and 108 is an RTC for measuring a time lapse.

Reference numeral 109 is a parameter storage section for storing a voice codec cycle, 110 is a codes section for A/D converting a voice input from the voice input section 102 to convert (encode) it into a voice packet using a predetermined algorithm, and D/A converting voice data after decoding using the predetermined algorithm to output it to the voice output section 103, 111 is a transmission packet queue for storing the voice packet encoded by the codec section 110 in a FIFO manner along with a time when encoding is completed, that is, a transmission request reception time, 112 is a payload integration section for merging a voice packet input to the transmission packet queue 111 within a transmission standby time into one radio frame and writing it to the transmission buffer, 113 is a reception packet queue for disassembling data received as a radio frame into packets and storing the packets in the FIFO manner, and 114 is a payload dividing section for determining whether or not content stored in the reception buffer 104 is originally intended for one packet, and writing the content to the reception packet queue 113 in the FIFO manner by disassembling it into a plurality of voice packets when the plurality of voice packets are integrated.

Reference numeral 116 is a call control section for outputting a dial tone, a busy tone, a ringer, or a ringback tone to the voice output section 103 according to an outgoing call, an incoming call, call connection/disconnection control, and each call state, 117 is a protocol processing section for processing a call setup or release and a voice packet transmission/reception at the time of a telephone call according to a designated protocol, 118 is a higher protocol analysis section for analyzing a higher protocol, 119 is an error determination section for computing an error rate and determining whether or not it is lower than a preset error rate, and 130 is a control section for the overall control.

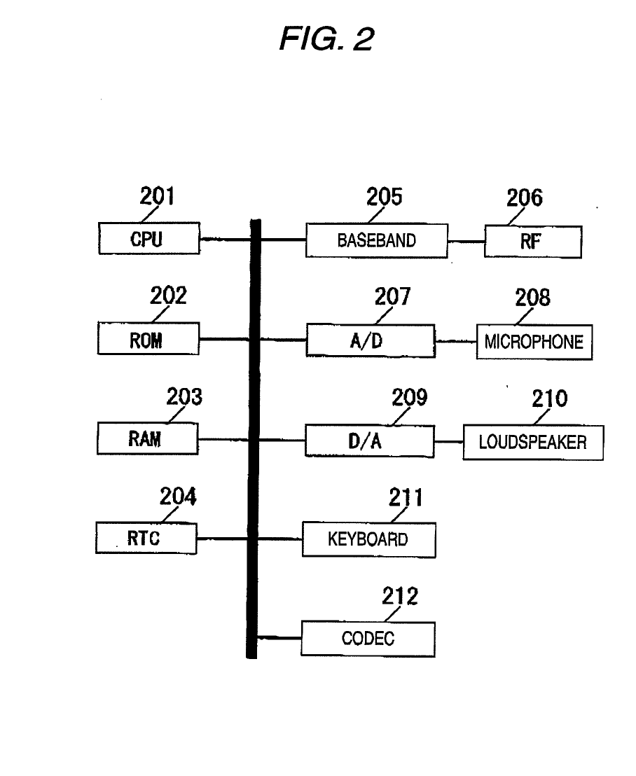

FIG. 2 is a device block diagram showing the slave unit of the wireless LAN telephone device in the first embodiment of the present invention.

In FIG. 2, reference numeral 201 is a central processing unit (hereinafter, referred to as CPU), 202 is a ROM, 203 is a RAM, 204 Is an RTC, 205 is a baseband, 206 is an RF, 207 is an A/D, 208 is a microphone, 209 is a D/A, 210 is a loudspeaker, 211 is a keyboard, and 212 is a codec.

In FIGS. 1 and 2, the operation section 101 is realized by the keyboard 211, the voice input section 102 is realized by the microphone 208, and the voice output section 103 is realized by the loudspeaker 210.

The reception buffer 104, the transmission buffer 105, the parameter storage section 109, the transmission packet queue 111, and the reception packet queue 113 are realized by the RAM 203.

The radio communication section 107 is realized by the baseband 205 and the RF 206, the RTC 108 is realized by the RTC 204, and the codes section 110 is realized by the codec 212, the A/D 207, and the D/A 209.

The payload integration section 112, the payload dividing section 114, the call control section 116, and the protocol processing section 117, the higher protocol analysis section 118, and the error rate determination section 119, and the control section 130 are realized when the CPU 201 executes a program stored in the ROM 202 while referring to data stored in the ROM 202 or referring to or changing data stored in the RAM 203.

Subsequently, a master unit of the wireless LAN telephone device will be described.

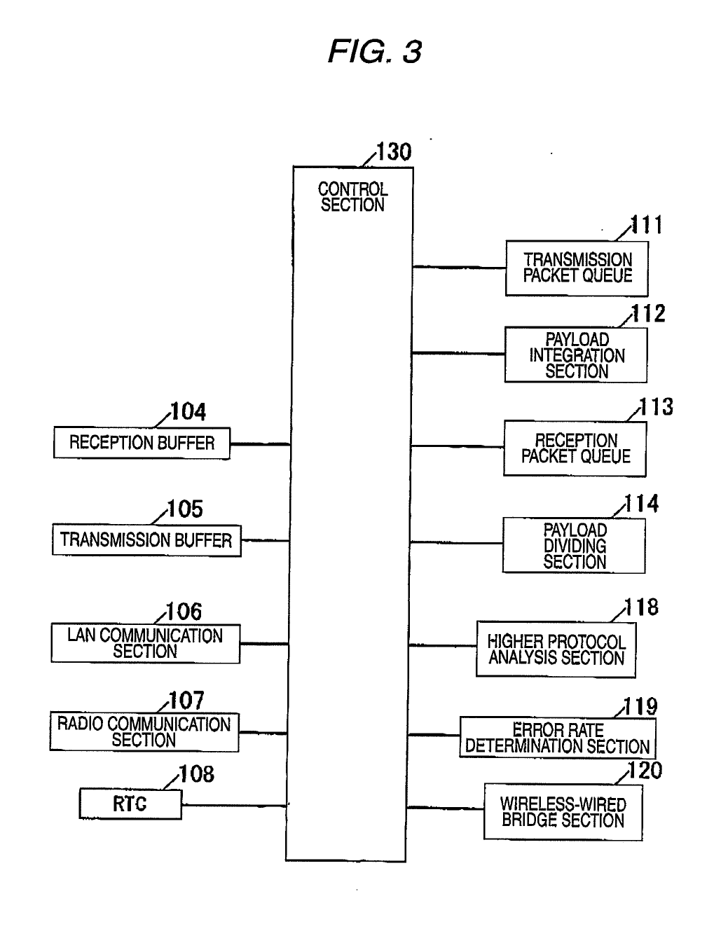

FIG. 3 is a functional block diagram showing the master unit of the wireless LAN telephone device in the first embodiment of the present invention.

In FIG. 3, reference numeral 104 is a reception buffer for accumulating data extracted from a received radio frame, 105 is a transmission buffer for accumulating radio transmission data, 106 is a LAN communication section for connecting with a wired network, 107 is a radio communication section for radio framing and transmitting the data accumulated in the transmission buffer 105 and receiving a radio frame to store frame content in the reception buffer 104, and 108 is an RTC for measuring a time lapse.

Reference numeral 111 is a transmission packet queue for storing an Ethernet (registered trademark) frame from a LAN side determined to be relayed in the FIFO manner along with a transmission request time such that a wired-wireless bridge section 120 described below radio frames and transmits it, 112 is a payload integration section for integrating a voice packet input to the transmission packet queue 111 within a transmission standby time into one radio frame and writing it to the transmission buffer, 113 is a reception packet queue for disassembling data received as a radio frame into packets and storing the packets in the FIFO manner, 114 is a payload dividing section for determining whether or not content stored in the reception buffer 104 is originally intended for one packet, and writing the content to the reception packet queue 113 in the FIFO manner by disassembling it into a plurality of voice packets when the plurality of voice packets are integrated, 118 is a higher protocol analysis section for analyzing a higher protocol, 119 is an error determination section for computing an error rate and determining whether or not it is lower than a preset error rate, 120 is the wired-wireless bridge section for relaying a frame between wired and wireless if needed and destroying the frame otherwise, and 130 is a control section for the overall control.

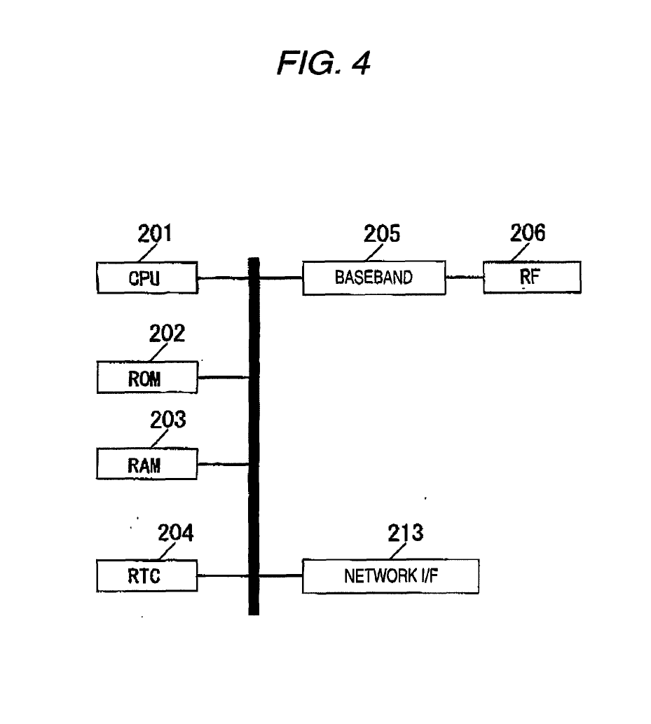

FIG. 4 is a device block diagram showing the master unit of the wireless LAN telephone device in the first embodiment of the present invention.

In FIG. 4, reference numeral 201 is a CPU, 202 is a ROM, 203 is a RAM, 204 is an RTC, 205 is a baseband, 206 is an RF, and 213 is a network I/F.

In FIGS. 3 and 4, the reception buffer 104, the transmission buffer 105, the transmission packet queue 111, and the reception packet queue 113 are realized by the RAM 203.

The radio communication section 107 is realized by the baseband 205 and the RF 206, the RTC 108 is realized by the RTC 204, and the LAN communication section 106 is realized by the network I/F 213.

The payload integration section 112, the payload dividing section 114, the higher protocol analysis section 118, and the error rate determination section 119, the wired-wireless bridge section 120, and the control section 130 are realized when the CPU 201 executes a program stored in the ROM 202 while referring to data stored in the ROM 202 or referring to or changing data stored in the RAM 203.

Subsequently, the overall configuration of a wireless LAN telephone system will be described.

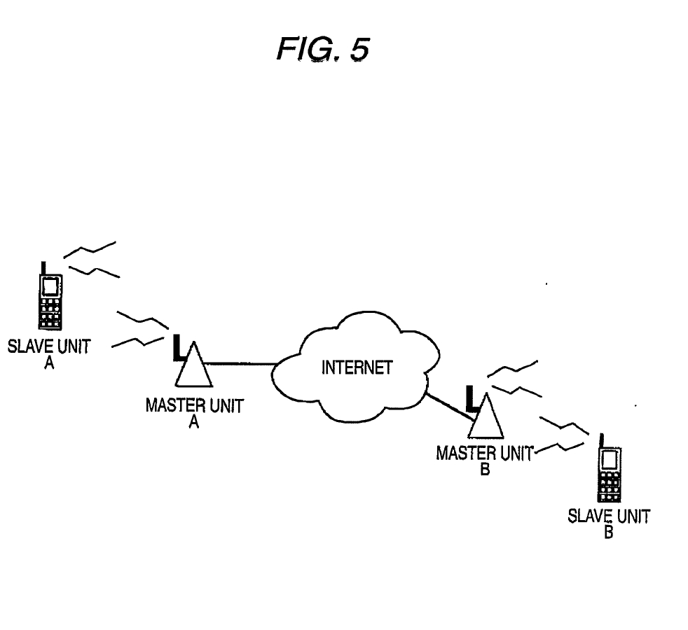

FIG. 5 is a view showing the wireless LAN telephone system in the first embodiment of the present invention.

As shown in FIG. 5, a slave unit A is under management of a master unit A, and similarly a slave unit B is under management of a master unit B. The master unit A and the master unit B are respectively connected to the Internet. The master unit A and the master unit B are equipped with a bridge function, and relay a radio frame from the slave unit as an Ethernet (registered trademark) frame to an Internet side using the LAN communication section (wired) or relay an Ethernet (registered trademark) frame from the Internet side as a radio frame to the slave unit.

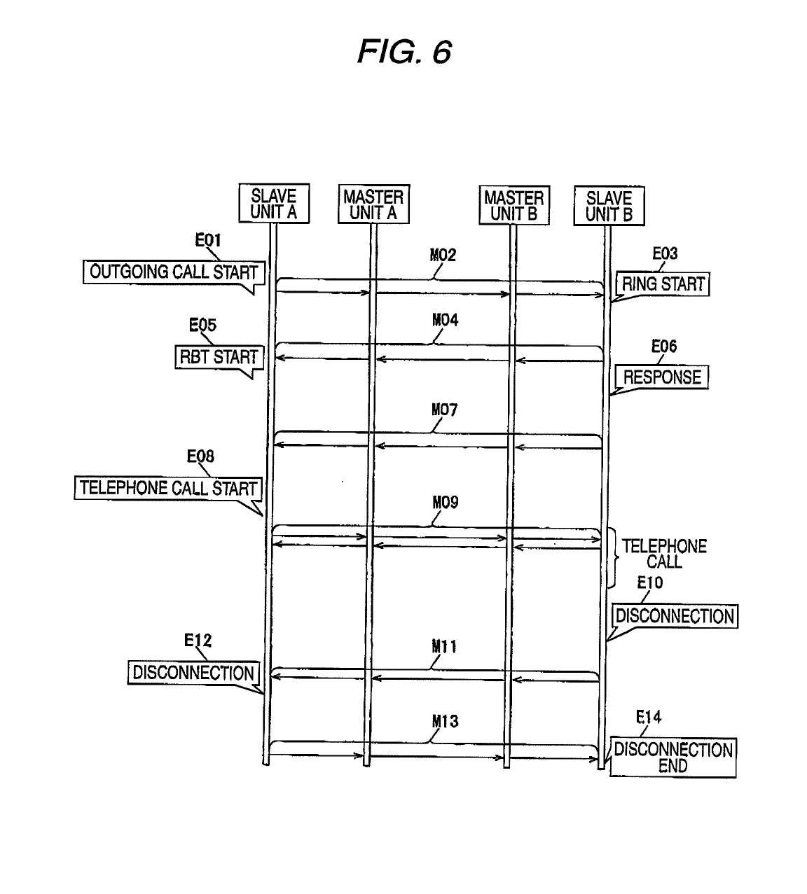

In the wireless LAN telephone system configured as described above, the operation of the master unit and the slave unit will be described according to a sequence chart of FIG. 6.

The operation described below refers to an SIP protocol recently being frequently used as a VoIP. In this regard, for convenience of explanation, the process is simplified in some degree and described. Herein, the description is given focusing on a collaboration of the master unit and the slave unit. Details of “encode” and “decode” of the slave unit, “bridge process” of the master unit, and “radio transmission” and “radio reception” of the master unit/slave unit will be described below. In this embodiment, it is assumed that the slave unit is first in the standby state.

Step E01

First, a user of the slave unit A designates an outgoing call destination using the operation section 101 of the slave unit A (step E01). Here, it is assumed that the user inputs an outgoing call destination number of 050-1001-1234 from the operation section 101 to make an outgoing call instruction.

Step M02

The control section 130 receives the input outgoing call destination number input from the operation section 101, and requests the call control section 116 to set up a call to the designated outgoing call destination number. The call control section 116 creates an “INVITE” message to notify the slave unit B of a “call connection request” and requests the protocol processing section 117 to transmit it to the slave unit B. The protocol processing section 117 transmits data meaning “INVITE” to the master unit A through the radio communication section 107 (and details will be described below in the “slave unit's transmission process”). The master unit A converts a received radio frame into a wired Ethernet (registered trademark) frame and transmits it to the Internet (and details will be described below in the “master unit's bridge process”). The Ethernet (registered trademark) frame transmitted from the master unit A arrives at the master unit B through the Internet (not shown). The master unit B relays the received Ethernet (registered trademark) fame, converts it into a radio frame, and transmits it to the slave unit B (and details will be described below in the “slave unit's bridge process”). The slave unit B receives the radio frame transmitted by the master unit B and notifies the call control section 116 of the “INVITE” message via the radio communication section 107 and the protocol processing section 117 (and details will be described below in the “slave unit's reception process”). Thereby, the slave unit B receives the incoming call.

Step E03

The slave unit B requests the call control section 116 to flow a ringer (ringtone) to the codec section 110. Then, the codec section 110 outputs a voice stored as the ringtone to the voice output section 103.

Step M04

In the slave unit B, the call controls section 116 creates a “RINGING” message to notify the slave unit A that “an incoming call has been received,” and requests the protocol processing section 117 to transmit it to the slave unit A. The protocol processing section 117 transmits data meaning “RINGING” to the master unit B via the radio communication section 107. This data is converted from the radio frame into the Ethernet (registered trademark) frame by the master unit B and is sent to the master unit A through the Internet. The master unit A relays the received Ethernet (registered trademark) frame and transmits it as a radio frame to the slave unit A.

Step E05

In the slave unit A, the call control section 116 receives the “RINGING” message via the radio communication section 107 and the protocol processing section 117, and knows that an outgoing call destination has received the incoming call. The call control section 116 requests the codec section 110 to output a ringback tone (calling sound, hereinafter abbreviated to RBT). Then, the codec section 110 outputs the RBT to the voice output section 103.

Step E06

When listening to a ringer and realizing that an incoming signal is received in the slave unit B, the user operates the operation section 101 and makes a telephone call instruction. Then, in the slave unit B, the control section 130 receives an indication that “the telephone call instruction has been made” from the operation section 101 and requests the call control section 116 to “connect the call.”

Step M07

In the slave unit B, the call control section 116 creates a “CONNECT-OK” message to notify the slave unit A that “the user has responded to the incoming call” and requests the protocol processing section 117 to transmit it to the slave unit A. The protocol processing section 117 transmits data meaning “CONNECT-OK” to the master unit B via the radio communication section 107. Then, the master unit B converts a radio frame received from the slave unit B into an Ethernet (registered trademark) frame to relay it, and the Ethernet (registered trademark) frame arrives at the master unit A through the Internet. The master unit A converts the arrived Ethernet (registered trademark) frame into a radio frame and relays and transmits it to the slave unit A. In the slave unit A, the call control section 116 receives “CONNECT-OK” via the radio communication section 107 and the protocol processing section 117 and requests the codes section 110 to stop an RBT. Then, the codec section stops the RBT.

Step E08

Thereafter, a full duplex communication path is secured and a telephone call is possible. Here, it is assumed that the Internet communication band is sufficiently wide and also the delay is about several 10 ms. That is, it is assumed that a communication bottleneck is present between the slave unit A and the slave unit B.

Step M09

During a telephone call, the voice of the user of the slave unit A is input to the voice input section 102 of the slave unit A and is encoded by the codec section 110 as described above, such that a voice packet is transmitted to the slave unit B by the protocol processing section 117. In the slave unit B, the codes section 110 receives and decodes the voice packet via the radio communication section 107 and the protocol processing unit 117, and outputs a result to the voice output section 103 of the slave unit B. Since a process in which the voice of the user from the slave unit B side arrives at the slave unit A is a process exactly symmetrical with the above-described process, a description is omitted.

Step E10

The user of the slave unit B makes a call disconnection instruction from the operation section 101 so as to end the telephone call. Then, the control section 130 receives a call disconnection instruction from the operation section 101 and requests the call control section 116 to disconnect the call. The call control section 116 stops the encode task and the decode task. Then, the codec section 110 stops the codec. Thereafter, the voice packet is destroyed even when it is received and also no voice input is encoded.

Step M11

In the slave unit B, the call control section 116 creates a “BYE” message and requests the protocol processing section 117 to transmit it to the slave unit A. The protocol processing section 117 transmits data meaning “BYE” to the master unit B via the radio communication section 107. As up to now, the “BYE” message arrives at the slave unit A via the master unit B, the Internet, and the master unit A.

Step E12

In the slave unit A, the call control section 116 receives the “BYE” message via the radio communication section 107 and the protocol processing section 117. The call control section 116 stops the encode task and the decode task. Then, the codec section 110 stops the codec. Thereafter, the voice packet is destroyed even when it is received and also no voice input is encoded,

Step M13

In the slave unit A, the call control section 116 creates a “BYE-OK” message and requests the protocol processing section 117 to transmit it to the slave unit B. The protocol processing section 117 transmits data meaning “BYE-OK” to the master unit A via the radio communication section 107. As up to now, the “BYE-OK” message arrives at the slave unit B via the master unit A, the Internet, and the master unit B.

Step E14

In the slave unit B, the call control section 116 receives the “BYE-OK” message via the radio communication section 107 and the protocol processing section 117. Thereafter, the slave unit B is in “standby mode.”

Next, an outline of the operation of the slave unit of this embodiment will be described.

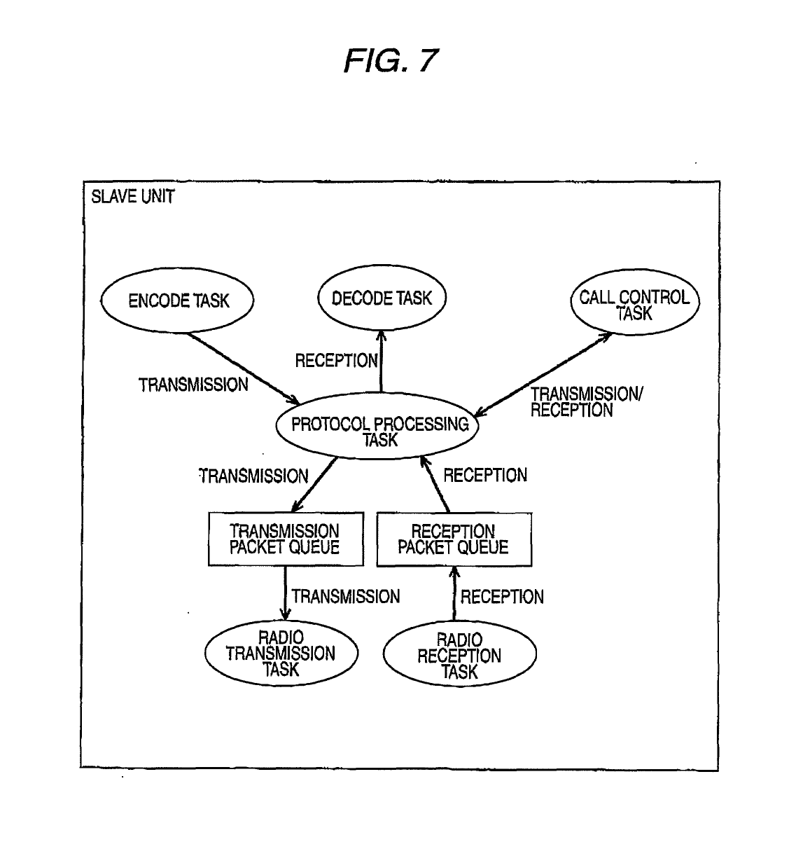

FIG. 7 shows a task configuration diagram of the slave unit in the first embodiment of the present invention.

In this embodiment, it is assumed that an encode task for encoding a voice, a decode task for decoding a voice, a call control task for performing a call setup, connection or disconnection, and the like, a radio transmission task for transmitting a voice packet stored in the transmission packet queue as a radio frame, and a radio reception task for receiving a radio frame, converting it into a voice packet, and writing it to the reception packet queue operate in parallel. The encode task, the decode task, and the call control task make a transmission request and a reception request to the protocol processing task. When the protocol processing task receives requested data after the reception request is made, the information is reported to the task having made the reception request. The arrow of the figure represents a data flow.

Next, an outline of the operation of the master unit of this embodiment will be described.

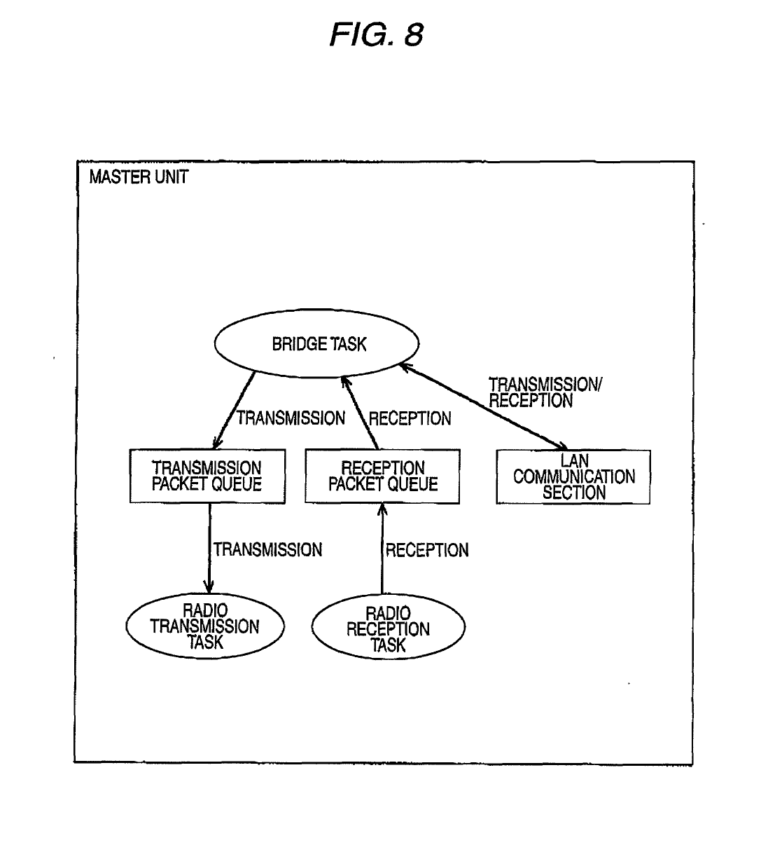

FIG. 8 shows a task configuration diagram of the master unit in the first embodiment of the present invention.

In the master unit, a radio transmission task and a radio reception task like those of the slave unit and a bridge task that “examines a radio frame received in the radio reception task, determines whether to relay a frame between wired and wireless, and transmits an Ethernet (registered trademark) frame via the LAN communication section 106 after converting a frame format if needed, and that examines an Ethernet (registered trademark) frame received via the LAN communication section 106, determines whether to relay a frame between wired and wireless, and passes it to the radio transmission task after Thereafter, the respective tasks of the slave unit will be described using flowcharts.

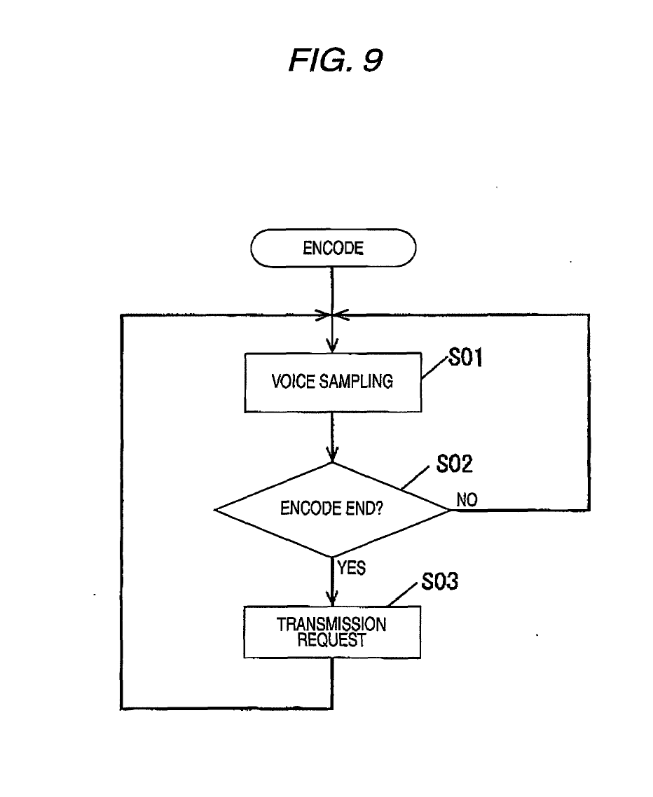

First, a process of the encode task will be described according to the flowchart of FIG. 9.

The encode task is started by the call control task during a telephone call, and is stopped by the call control task when the telephone call ends. The following description is given of the operation of the encode task during the telephone call.

Step S01

The codec section 110 receives, samples (AND converts) and encodes a voice from the voice input section 102.

Step S02

The codec section 110 refers to a codec interval stored in the parameter storage section 109, and determines whether or not encoding is performed in a time specified in the codec interval while comparing with the RTC 108. If the specified time has elapsed, it proceeds to step S03. Otherwise, it returns to step S01.

Step S03

The codec section 110 passes sampled data to the protocol processing section 117 and makes a transmission request. It proceeds to step S01.

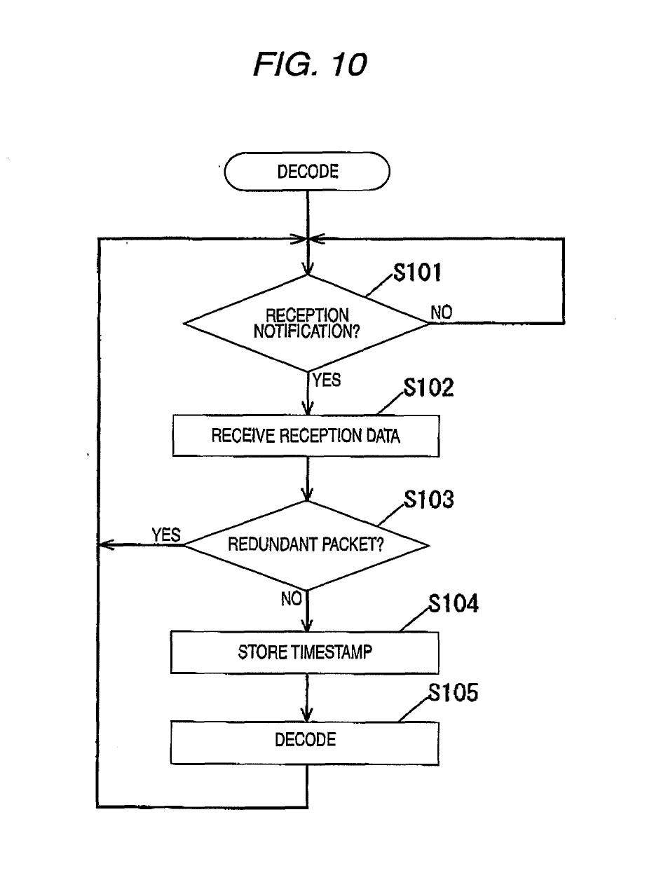

Next, a process of the decode task will be described according to the flowchart of FIG. 10.

The decode task is started by the call control task during a telephone call, and is stopped by the call control task when the telephone call ends. The following description is given of the operation of the decode task during the telephone call.

Step S101

The codec section 110 checks whether or not a reception notification is received from the protocol processing section 117. When the reception notification is received, it proceeds to step S102. Otherwise, it returns to step S101.

Step S102

The codec section 110 receives reception data from the protocol processing section 117.

Step S103

The codes section 110 refers to an RTP header of the received data and determines whether or not it is equal to a timestamp of the previous reception data. When they are the same, it proceeds to step S101. Otherwise, it proceeds to step S104.

Step S104

The codec section 110 stores a timestamp written to the RTP header of the received data.

Step S105

The codec section 110 decodes the received data, D/A converts a result, and outputs its output to the voice output section 103. It proceeds to step S101.

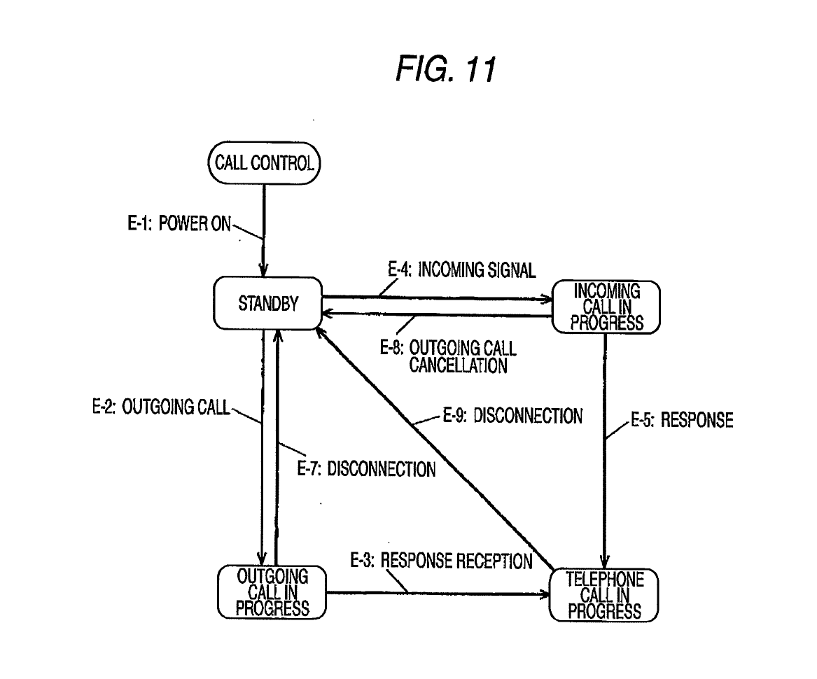

Next, the operation of the call control task will be described according to the state chart of FIG. 11.

First, in a series of processes in which a power supply of the slave unit A is turned ON and the user of the slave unit A makes an outgoing call, a telephone call, and a disconnection, the operation of the call control task will be described from the side of the slave unit A.

Step E-1

When a power ON instruction of the slave unit is made from the operation section 101, the control section 130 starts the call control task, the protocol processing task, the radio transmission task, and the radio reception task. When the call control task is started, the transition to the standby state is made. Thereafter, an outgoing/incoming call is possible.

Step E-2

The slave unit A makes an outgoing call to the slave unit B by operating the operation section 101. The control section 130 of the slave unit A receives a notification of the “outgoing call” from the operation section 101, receives an outgoing call destination number, and makes a “call connection” request to the call control section 116. The call control section 116 requests the protocol processing section 117 to transmit an “INVITE” message to the slave unit B. The slave unit B is in an incoming call state by receiving the “INVITE” message, and returns a “RINGING” message to the slave unit A. The call control section 116 of the slave unit A receives the “RINGING” message from the slave unit B via the protocol processing section 117 and transits to a state in which the outgoing call is in progress. The call control section 116 outputs an RBT to the voice output section 103 and allows the user to know that “calling is in progress.”

Step E-3

In the slave unit B, a ringer (ringtone) rings and the user is conscious of the ringtone and receives an incoming signal. Then, after the encode task and the decode task are started, a “CONNECT-OK” message is transmitted to the slave unit A. In the slave unit A, the call control section 116 receives the “CONNECT-OK” message via the protocol processing section 117. Then, the call control section 116 starts the encode task and the decode task described above, and the codec section 110 A/D converts and encodes a subsequent voice from the voice input section 102 and passes a voice packet to the protocol processing section 117. The codes section 110 decodes and D/A converts a voice packet received by the protocol processing section 117 and outputs it to the voice output section 103. The transition to a state in which a telephone call is in progress is made.

Step E-9

When the telephone call ends, the user of the slave unit A operates the operation section 101 of the slave unit A and disconnects the call. The control section 130 receives a notification of the disconnection operation from the operation section 101 and makes a “call disconnection” request to the call control section 116. The call control section 116 stops the encode task and the decode task. Then, the call control section 116 requests the protocol processing section 117 to transmit a “BYE” message to the slave unit B. The protocol processing section 117 transmits data meaning the “BYE” message to the master unit A via the radio processing section 107, such that it arrives at the slave unit B via the Internet and the master unit B. When the slave unit B receives the “BYE” message, “BYE-OK” is returned to the slave unit A. In the slave unit A, the call control section 116 receives the “BYE-OK” message via the radio communication section 107 and the protocol processing section 117. Then, the transition to the standby state is made.

Step E-7

When the user cancels an outgoing call during the outgoing call, an outgoing call cancellation instruction from the operation section 101 is performed, such that the control section 130 receives the outgoing call cancellation instruction from the operation section 101 and requests the call control section 116 to cancel the outgoing call. The call control section 116 requests the protocol processing section 117 to transmit a “CANCEL” message to the slave unit B. The slave unit B stops the ringer and transmits a “CANCEL-OK” message to the slave unit A. In the slave unit A, the protocol processing section 117 receives “CANCEL-OK” from the slave unit B and notifies the call control section 116 thereof, such that the call control section 116 transits to the standby state.

Next, the operation of the call control task viewed from the slave unit B side will be described.

Step E4

The protocol processing section 117 receives an “INVITE” message from the slave unit A and notifies the call control section 116 thereof. The call control section 116 requests the protocol processing section 117 to return a “RINGING” message to the slave unit A. The call control section 116 outputs the ringer to the voice output section 103 and notifies the user of the occurrence of an incoming signal. The call control section 116 transits to a state in which the incoming call is in progress.

Step E-5

The user knows the incoming call by the ringer, operates the operation section 101, and responds to the incoming signal. The control section 130 receives the response to the incoming signal from the operation section 101 and requests the call control section 116 to make the response. Then, the call control section 116 requests the protocol processing section 117 to transmit a “CONNECT-OK” message to the slave unit A. The protocol processing section 117 transmits the “CONNECT-OK” message to the slave unit A. Moreover, the call control section 116 stops a ringer output to the voice output section 103, starts the encode task and the decode task, causes a subsequent voice from the voice input section 102 to be A/D converted and encoded such that a voice packet is transmitted to the slave unit A, and causes a voice packet from the slave unit A to be decoded and D/A converted such that it is output from the voice output section 103.

Step E-9

The protocol processing section 117 receives a “BYE” message from the slave unit A and notifies the call control section 116 thereof. The call control section 116 stops the encode task and the decode task and transits to the standby state.

When the user of slave unit A cancels an outgoing call during the outgoing call, it is as follows.

Step E-8

The protocol processing section 117 receives a “CANCEL” message and notifies the call control section 116 thereof. The call control section 116 stops the ringer, requests the protocol processing section 117 to transmit a “CANCEL-OK” message to the slave unit A, and transits to the standby state.

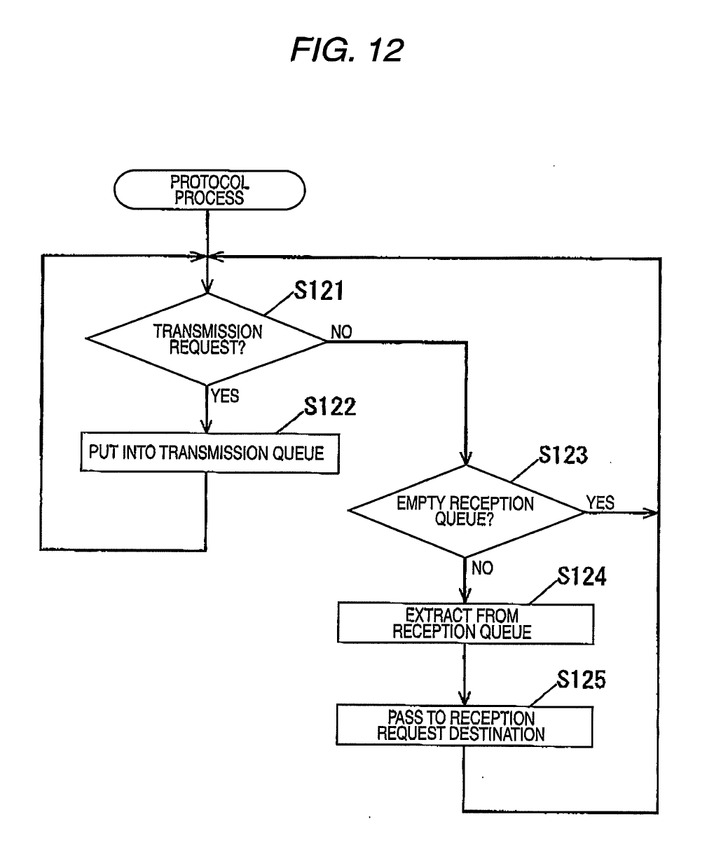

Next, the operation of the protocol processing task will be described according to the flowchart of FIG. 12.

Step S121

The protocol processing section 117 checks whether or not there is a transmission request from the encode task, the decode task, and the call control task. If so, it proceeds to step S122. Otherwise, it proceeds to step S123.

Step S122

The protocol processing section 117 receives the transmission request, adds a header according to each protocol, and inputs it to the transmission packet queue 111. The transmission packet queue 111 is prepared for every destination. Here, the destination is a transmission destination MAC address defined in IEEE 802.11. At this time, a transmission request reception time is mapped to the transmission request and is written with reference to the RTC 108. It proceeds to step S121.

Here, it is described that a voice packet is received from the encode task. The protocol processing section 117 adds an RTP header, a UDP header, an IP header, or an LLC header to the voice packet and determines a MAC address of the destination (the destination is usually assigned an IP address and the protocol processing section 117 converts it into a MAC address. Details are omitted since they are the same as those of usual TCP/IP communication processing). The protocol processing section 117 selects a transmission packet queue having a MAC address of a destination of a voice packet from among transmission packet queues 111 prepared on a MAC address basis and puts the voice packet into the transmission packet queue 111. At this time, a transmission request reception time is written to the transmission packet queue with reference to the RTC 108. It proceeds to step S121.

Step S123

The protocol processing section 117 checks whether or not data arrives at the reception packet queue 113. When the data arrives, it proceeds to step S124. Otherwise, it proceeds to step S121.

Step S124

The protocol processing section 117 extracts reception data from the reception packet queue 113.

Step S125

A destination of the data is checked. When the destination is the decode task, the decode task is notified thereof. When the destination is the call control task, the call control task is notified thereof. It proceeds to step S121.

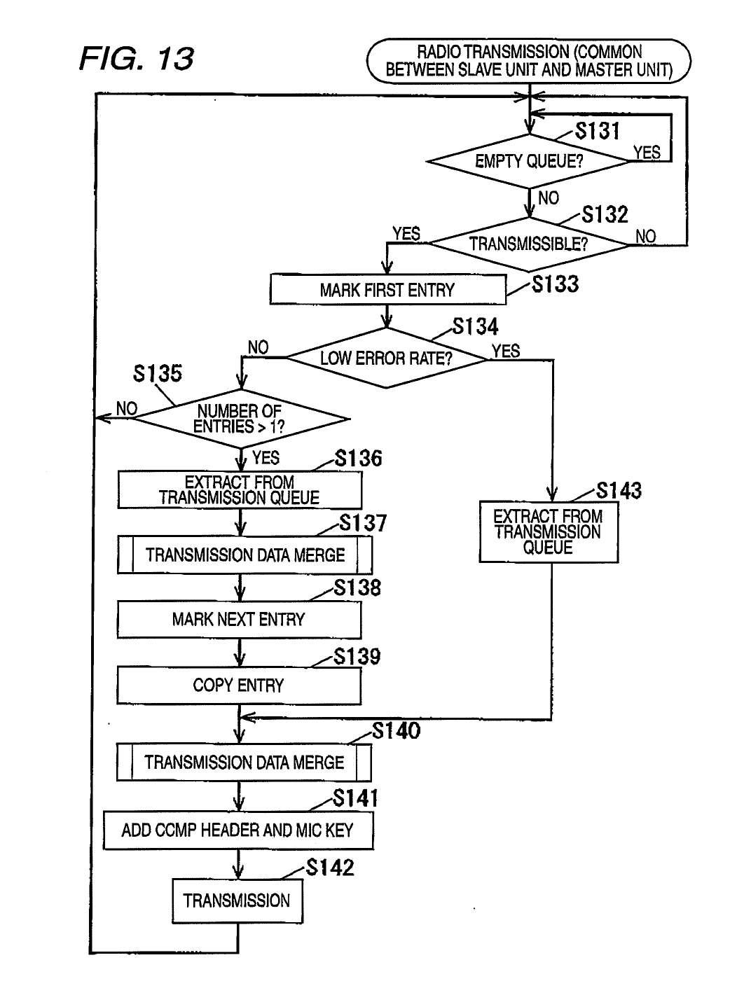

Next, the operation of the radio transmission task will be described according to the flowchart of FIG. 13.

In the radio transmission task in this embodiment, both the slave unit and the master unit perform the same process. The transmission packet queue 111 is present for every destination MAC address, and the radio transmission task performs the following process for every transmission packet queue 111. In this regard, in the following description, the operation will be described by observing one transmission packet queue 111.

Step S131

The control section 130 determines whether or not the queue is empty with reference to the transmission packet queue 111. When the queue is empty, it proceeds to step S131. Otherwise, it proceeds to step S132.

Step S132

The control section 130 asks the radio communication section 107 whether or not the transmission is possible. Specifically, the radio communication section 107 determines whether or not there is a radio wave of a frequency at which present communication is performed, and checks that there is no radio wave in a preset time with reference to the RTC 108. When no radio wave has been detected even though the above-described time has elapsed, the transmission is determined to be possible and the control section 130 is notified of the fact that the transmission is possible. When a radio wave has been detected within the above-described time, the control section 130 is notified of the fact that the transmission is impossible. When the transmission is possible, it proceeds to step S133. When the transmission is impossible, it proceeds to step S131.

Step S133

The control section 130 marks a first entry of the transmission packet queue 111.

Step S134

The control section 130 asks the error rate determination section 119 whether or not an error rate is lower than a threshold value achieved by presetting an error rate. The error rate determination section 119 passes a determination result to the control section 130. When the error rate is lower from the received determination result, it proceeds to step S143. Otherwise, it proceeds to step S135.

Herein, the case where the error rate is higher will be continuously described.

Step S135

The control section 130 determines whether or not the number of entries is larger than 1 with reference to the transmission packet queue 111. When the number of entries is larger than 1, it proceeds to step S136. Otherwise, it proceeds to step S131.

Step S136

The control section 130 extracts data of a marked entry from the transmission packet queue 111.

Step S137

The control section 130 instructs the payload integration section 112 to merge data extracted in step S136. Details will be described below. Data to be transmitted is written to the transmission buffer 105.

Step S138

The control section 130 marks the next entry.

Step S139

The control section 130 copies data of the marked entry. Here, the data is only copied without extracting the entry from the transmission packet queue 111.

Step S140

The control section 130 instructs the payload integration section 112 to merge the data copied in step S139 or data extracted in step S143. Details will be described below. Data to be transmitted is written to the transmission buffer 105.

Step S141

Herein, it is assumed that a radio frame is encrypted by an encryption system defined in IEEE 802.11i. The control section 130 instructs the radio communication section 107 to add a CCMP header and an MIC key. Then, the radio communication section 107 computes the CCMP header and the MIC key according to an encryption algorithm and adds them to payload positions defined in IEEE 802.11i of the transmission buffer 105.

Step S142

The control section 130 instructs the radio communication section 107 to transmit content of the transmission buffer 105. Then, the radio communication section 107 sends the instructed content as a radio frame into the air. It proceeds to step S131.

In this way, two voice packets are merged into one radio frame. Upon determining that the error rate is lower in step S134, it is as follows.

Step S143

The same process as step S136 is performed. A flow proceeding to step S140 is made. In this case, a process is performed in which the packet is directly transmitted in one radio frame as in the conventional wireless LAN.

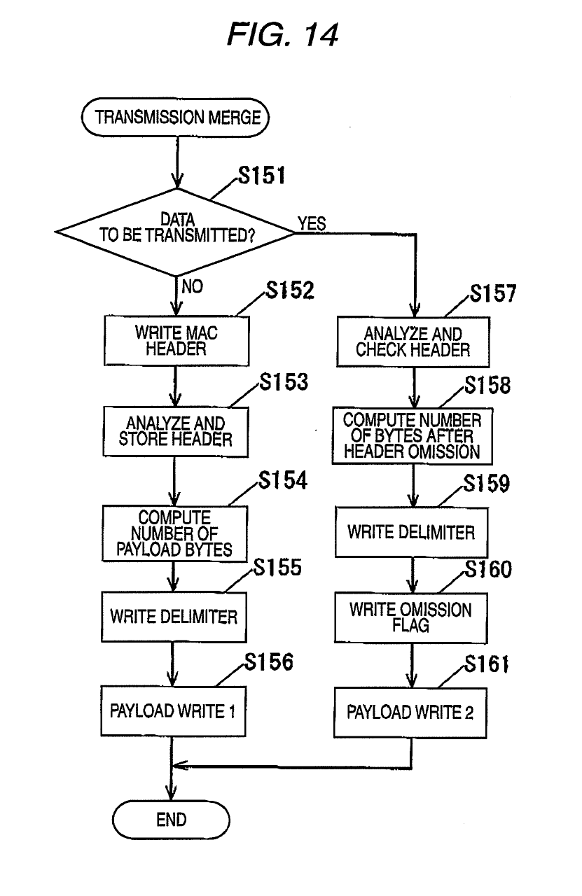

Next, details of the merge process will be described according to the flowchart of FIG. 14.

Herein, it is assumed that data to be transmitted is passed to the payload integration section 112 by the control section 130.

Step S151

The payload integration section 112 determines whether or not data is written to the transmission buffer 105. When the data is written, it proceeds to step S157. Otherwise, it proceeds to step S152.

Step S152

The payload integration section 112 writes a MAC header to the transmission buffer 105.

Step S153

The payload integration section 112 passes entry content to the higher protocol analysis section 118. Then, the higher protocol analysis section 118 identifies a protocol header of a higher protocol (herein, LLC, IP, UDP, RTP) within the packet and stores each layer header. When a previous higher protocol header is already stored, it is overwritten.

Step S154

The payload integration section 112 computes the total number of bytes of a received voice packet. Here, LLC Header (8 bytes)+IPv6 Header (40 bytes)+UDP Header (8 bytes)+RTP Header (12 bytes)+Voice (80 bytes)=148 bytes.

Step S155

The payload integration section 112 writes the total number of bytes obtained in step S154 as a payload delimiter 1 to the transmission buffer 105. Here, a value of 148 is written.

Step S156

The payload integration section 112 writes the data received as the voice packet to the transmission buffer 105. The merge process ends.

Step S157

The payload integration section 112 passes entry content to the higher protocol analysis section 118. Then, the higher protocol analysis section 118 identifies a protocol header of a higher protocol (herein, LLC, IP, UDP, RTP) within the packet and compares with the content stored in step S153. The higher protocol analysis section 118 passes a header analysis result to the payload integration section 112. Here, the payload integration section 112 is notified of the fact that the LLC header, the IP header, and the UDP header are redundant.

Step S158

The payload integration section 112 omits the redundant header and computes the total number of bytes of data to be transmitted. Here, a total value of 93 including a 1-byte flag indicating which is the redundant header, a 12-byte RTP header incapable of being omitted, and 80-byte voice data is computed.

Step S159

The payload integration section 112 writes the value computed in step S158 as the payload delimiter to the transmission buffer 105. Here, the value of 93 is written.

Step S160

Next, the payload integration section 112 writes the 1-byte flag indicating which is the redundant header to the transmission buffer 105. Here, the flag is expressed by two bits in each of a second layer, a third layer, a fourth layer, and fifth to seventh layers according to an OSI layer model, and 00 indicates that “there is no originally corresponding header,” 01 indicates that “a header is present but is omitted due to redundancy,” and 10 indicates that “omission is impossible.” Here, since the LLC header, the IP header, and the UDP header can be omitted and the RTP header cannot be omitted, a flag value is 01010110.

Step S161

The payload integration section 112 writes a header incapable of being omitted and voice data to the transmission buffer 105. The merge process ends.

Here, the 12-byte RTP header and the 80-byte voice data are subsequently written to the transmission buffer 105.

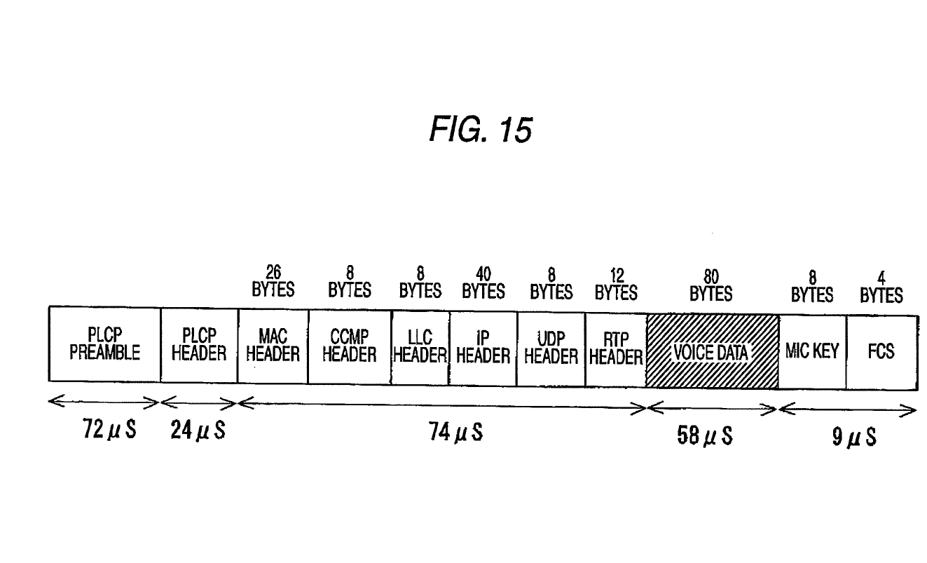

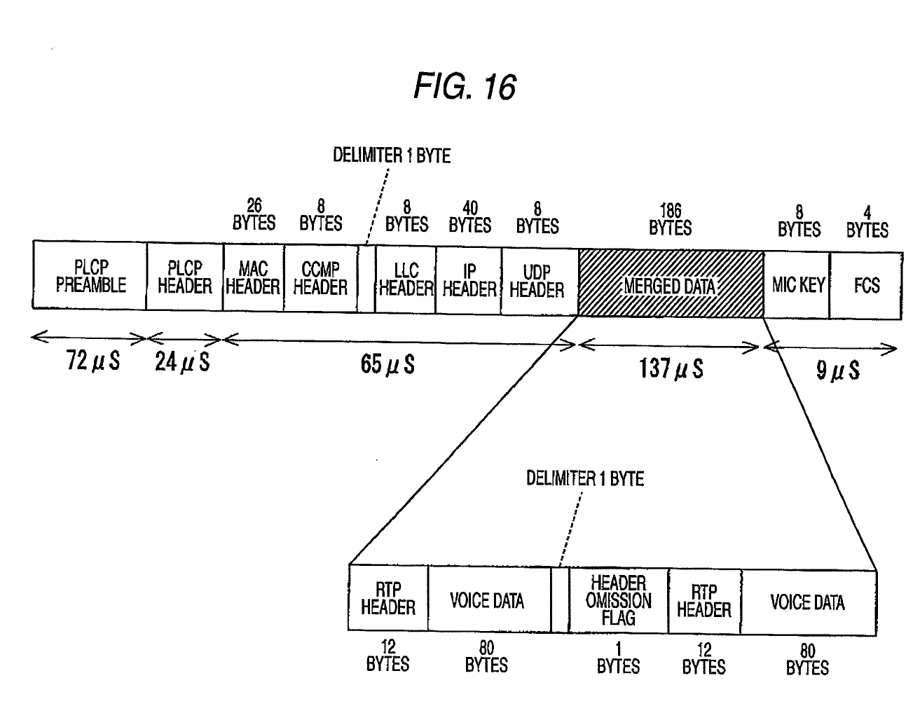

FIG. 15 shows the case where only one voice packet is transmitted using a radio frame format of IEEE 802.11 as compared with this embodiment. FIG. 16 shows a radio frame format in which two voice packets are merged into one radio frame by this embodiment.

First, after a CCMP header is written by an encryption engine embedded into the radio communication section 107 and an MIC key is added, a PLCP preamble, a PLCP header, and an FCS are added when the radio communication section 107 generates a radio frame. From the comparison between FIGS. 15 and 16, it can be seen that a redundant voice packet can be transmitted without significantly reducing the transmission efficiency since only a frame length increases by 25% when two original voice packets are merged into one frame without being transmitted in two frames. Thereby, the voice packet can be restored at a receiving side without delaying and retransmitting the voice since the lost voice packet is included in the previous or next radio frame even when one of radio frames in the middle is lost due to an error.

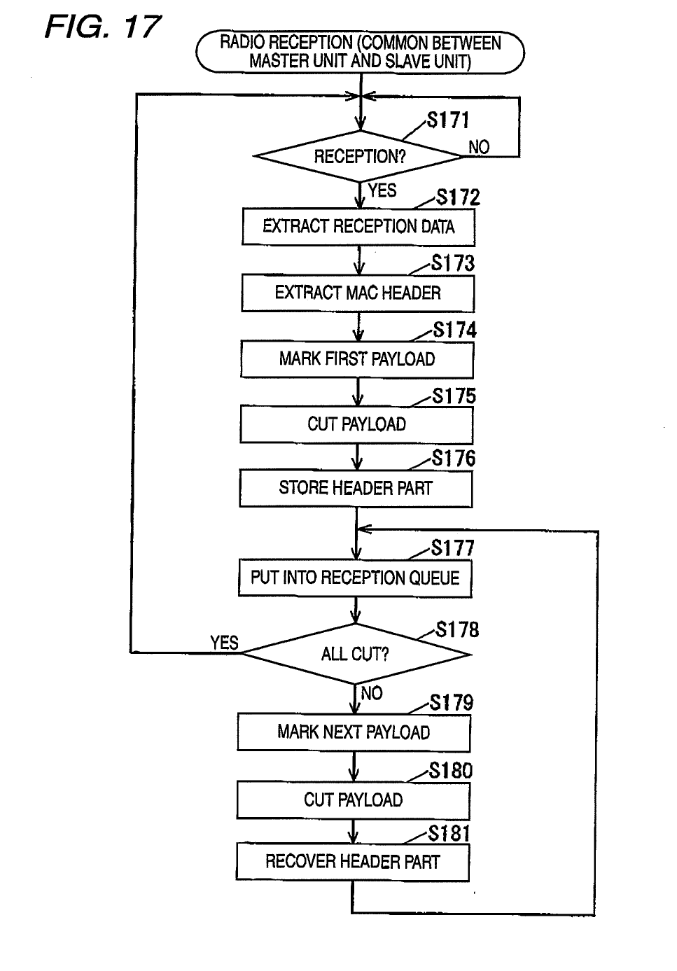

Next, the operation of the radio reception task will be described according to the flowchart of FIG. 17.

Here, it is assumed that a radio frame destined for a local station is received by the radio communication section 107 and frame content is written as data to the reception buffer 104 in a state in which a cipher is released. That is, it is assumed that a CCMP header and an MIC key are removed. Here, it is assumed that others except a radio frame destined for the local station are neglected. That is, it is assumed that data written to the reception buffer is limited to that destined for the local station.

Step S171

The payload dividing section 114 determines whether or not data is received with reference to the reception buffer 104. When the data is received, it proceeds to step S172. Otherwise, it proceeds to step S171.

Step S172

The payload dividing section 114 extracts data from the reception buffer 104.

Step S173

The payload dividing section 114 extracts a MAC header.

Step S174

The payload dividing section 114 marks a first payload.

Step S175

The payload dividing section 114 analyzes the next 1 byte as the delimiter, reads a value, and acquires the number of bytes of the payload, and cuts the payload by the number of bytes.

Step S176

The payload dividing section 114 passes the payload acquired in step S175 to the higher protocol analysis section 118. Then, the higher protocol analysis section 118 analyzes headers of a first layer, a second layer, a third layer, a fourth layer, and fifth to seventh layers and the payload dividing section 114 is notified thereof. Here, it is assumed that an LLC header, an IP header, a UDP header, and an RTP header can be analyzed. The higher protocol analysis section 118 stores the header for every layer.

Step S177

The payload dividing section 114 puts the acquired payload into the reception packet queue 113.

Step S178

The payload dividing section 114 determines whether or not every payload has been cut with reference to the reception buffer 104. When every payload has been completely cut, it proceeds to step S171. Otherwise, it proceeds to step S179.

Step S179

The payload dividing section 114 marks the next payload with reference to the reception buffer 104.

Step S180

The payload dividing section 114 analyzes the next 1 byte of the reception buffer 104 as the delimiter, reads a value, and acquires the number of bytes of the marked payload, and cuts the payload by the number of bytes.

Step S181

The payload dividing section 114 analyzes the next 1 byte as an omission flag, and determines which layer header is omitted. For the omitted header, the higher protocol analysis section 118 is instructed to restore the header from the header content stored in step S176. Then, the higher protocol analysis section 118 compares the payload and the content stored in step S176, and restores each layer header. Here, since a checksum is included in the IP header and the UDP header, the checksum is computed from the payload content and the header is restored. With that, the whole voice packet before the header is not omitted is restored. It proceeds to step S177.

When a flag value is 01010110, the flag is expressed by two bits in each of a second layer, a third layer, a fourth layer, and fifth to seventh layers according to an OSI layer model, and 00 indicates that “there is no originally corresponding header,” 01 indicates that “a header is present but is omitted due to redundancy,” and 10 indicates that omission is impossible,” such that it can be analyzed that the LLC header is omitted, the IP header is omitted, the UDP header is omitted, and the RTP header is not omitted. Therefore, it is analyzed that the RTP header is subsequent to the marked flag and the omitted header is restored on the basis of the content stored in step S176. Furthermore, the headers are restored by recomputing the checksum in relation the IP header and the UDP header.

According to the above process, even when two original voice packets are merged into one radio frame, it is correctly divided into voice packets and is passed to the protocol processing section 117.

When communication is normally performed, two same packets are received. However, there is no problem since the decode task destroys an unnecessary packet while checking a timestamp within the RTP header, decodes only a necessary packet, and reproduces it as a voice as shown in the above description of the decode task in the RTP protocol.

Next, the task of the master unit will be described. In this regard, since the radio reception task and the radio transmission task are the same as those of the slave unit, a description is omitted.

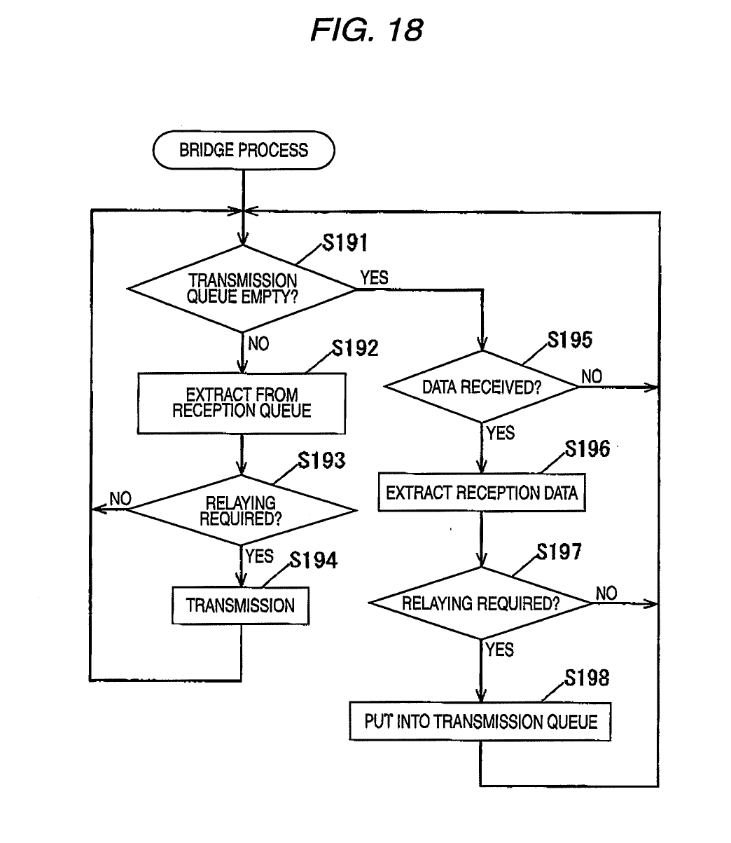

The process of the bridge task will be described according to the flowchart of FIG. 18.

Step S191

The wired-wireless bridge section 120 determines whether or not there is an entry in the reception packet queue 113. When there is the entry, it proceeds to step S192. Otherwise, it proceeds to step S195.

Step S192

The wired-wireless bridge section 120 extracts the entry from the reception packet queue 113.

Step S193

The wired-wireless bridge section 120 determines whether or not relaying to the LAN side (wired) is required with reference to content of the entry extracted in step S192. In this determination, a destination of the OSI second layer is used. In this embodiment, the second layer makes the determination by a MAC address defined in IEEE 802.11. Since an address learning method for this determination or the like is not related to the gist of the present invention, a description is omitted. When relaying is required, it proceeds to step S194. Otherwise, it proceeds to step S191.

Step S194

The wired-wireless bridge section 120 converts a MAC header format of IEEE 802.11 into a MAC header format of IEEE 802.3 and transmits the entry content from the LAN communication section 106. It proceeds to step S191.

Step S195

The wired-wireless bridge section 120 asks the LAN communication section 106 whether or not data is received from the wired LAN. When the reception is made, it proceeds to step S196. Otherwise, it proceeds to step S191.

Step S196

The wired-wireless bridge section 120 receives the received data from the LAN communication section 106.

Step S197

The wired-wireless bridge section 120 determines whether or not the received data extracted in step S196 needs to be relayed to the wireless LAN side. Since a method for determining whether relaying is required is the same as the conventional bridge process, a description is omitted. When relaying is required, it proceeds to step S198. Otherwise, it proceeds to step S191.

Step S198

The wired-wireless bridge section 120 converts the received data extracted in step S196 from the MAC header format of IEEE 802.3 into the MAC header format of IEEE 802.11, and puts it into the transmission packet queue 111. It proceeds to step S191.

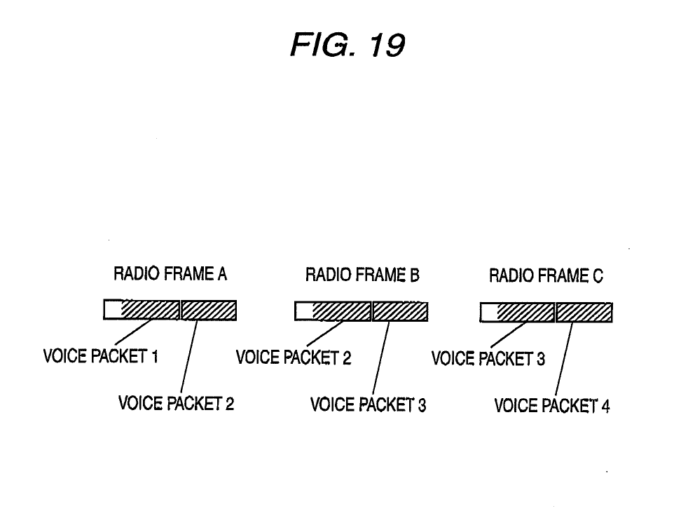

FIG. 19 shows how voice packets are transmitted in this embodiment.

In FIG. 19, a voice packet I and a voice packet 2 are merged and transmitted in a radio frame A, the voice packet 2 and a voice packet 3 are merged and transmitted in a radio frame B, and the voice packet 3 and a voice packet 4 are merged and transmitted in a radio frame C.

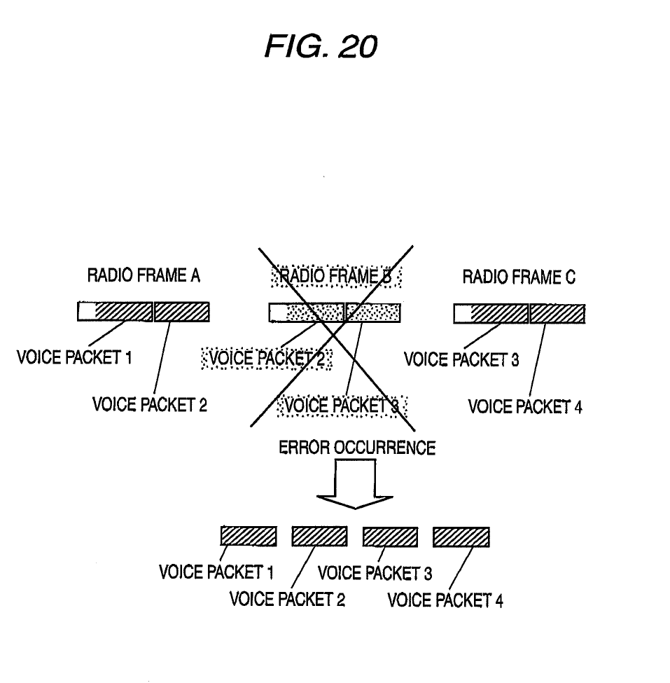

FIG. 20 shows the case where the radio frame B is lost due to a communication error. The receiving side can receive the voice packet 1, the voice packet 2, the voice packet 3, and the voice packet 4 by the radio frame A and the radio frame C. Therefore, the radio frame B does not need to be retransmitted.

As described above, a retransmission is conventionally inevitable due to error occurrence and a delay is accumulated, thereby resulting in the overflow of a jitter buffer in a reception terminal side and leading to the quality degradation of voice interruption or the like, but the same voice packet is transmitted in separate frames by the above-mentioned configuration according to this embodiment, such that the number of retransmissions can be reduced and a high-quality telephone call having a small delay is possible since the same packet is included in the other frame even when an error occurs in one frame.

Since the voice packets are merged and transmitted in one radio frame, a bandwidth is not unnecessarily pressed. Since the voice packets are analyzed and merged into one radio frame by omitting an unnecessary header, an amount of data per frame can be reduced. Thereby, a high-quality telephone call environment can be provided to a person using the wireless LAN telephone and a good communication environment can be provided to a user for performing data communication within the same wireless LAN without unnecessarily pressing the band.

### Second Embodiment

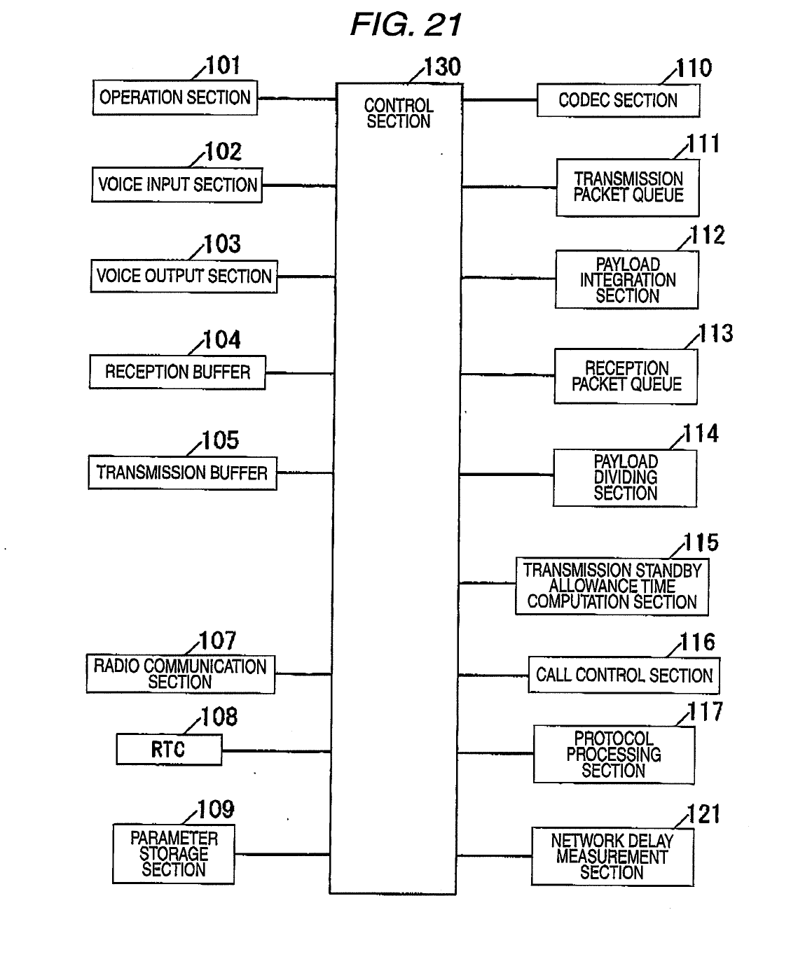

FIG. 21 is a functional block diagram of a slave unit of a second embodiment of the present invention.

In FIG. 21, reference numeral 101 is an operation section for designating an outgoing call destination and making a telephone call instruction at the time of an incoming call and a call end instruction, 102 is a voice input section for inputting a voice, 103 is a voice output section for outputting a voice, 104 is a reception buffer for accumulating data extracted from a received radio frame, and 105 is a transmission buffer for accumulating radio transmission data.

Reference numeral 107 is a radio communication section for radio framing and transmitting the data accumulated in the transmission buffer 105 and receiving a radio frame to store frame content in the reception buffer 104, 108 is an RTC for measuring a time lapse, and 109 is a parameter storage section for storing a voice delay allowance time, a voice codec cycle, a voice codec delay, and a preset network delay amount.

Reference numeral 110 is a codec section for A/D converting a voice input from the voice input section 102 to convert (encode) it into a voice packet using a predetermined algorithm, and D/A converting voice data after decoding using the predetermined algorithm to output it to the voice output section 103, 111 is a transmission packet queue for storing the voice packet encoded by the codec section 110 in a FIFO manner along with a time when encoding is completed, that is, a transmission request reception time, and 112 is a payload integration section for merging a voice packet input to the transmission packet queue 111 within a transmission standby time into one radio frame and writing it to the transmission buffer.

Reference numeral 113 is a reception packet queue for disassembling data received as a radio frame into packets and storing the packets in the FIFO manner, and 114 is a payload dividing section for determining whether or not content stored in the reception buffer 104 is originally intended for one packet, and writing the content to the reception packet queue 113 in the FIFO manner by disassembling it into a plurality of voice packets when the plurality of voice packets are integrated.

Reference numeral 115 is a transmission standby allowance time computation section for referring to the voice delay allowance time, the voice codec cycle, the voice codec delay, and the preset network delay amount stored in the parameter storage section 109, comparing a value of the RTC 108 with a transmission request reception time, and computing an allowance time of transmission standby.

Reference numeral 116 is a call control section for outputting a dial tone, a busy tone, a ringer, or a ringback tone to the voice output section 103 according to an outgoing call, an incoming call, call connection/disconnection control, and each call state, 117 is a protocol processing section for processing a call setup or release and a voice packet transmission/reception at the time of a telephone call according to a designated protocol, 121 is a network delay measurement section for measuring a network delay, and 130 is a control section for the overall control.

The correspondence relationship between the configuration of FIG. 21 and the configuration of FIG. 2 will be described.

The operation section 101 is realized by a keyboard 211, the voice input section 102 is realized by a microphone 208, and the voice output section 103 is realized by a loudspeaker 210.

The reception buffer 104, the transmission buffer 105, the parameter storage section 109, the transmission packet queue 111, and the reception packet queue 113 are realized by a RAM 203.

The radio communication section 107 is realized by a baseband 205 and an RF 206, the RTC 108 is realized by an RTC 204, and the codec section 110 is realized by a codec 212, an AND 207, and a D/A 209.

The payload integration section 112, the payload dividing section 114, the transmission standby allowance time computation section 115, the network delay measurement section 121, and the control section 130 are realized when a CPU 201 executes a program stored in a ROM 202 while referring to data stored in the ROM 202 or referring to or changing data stored in the RAM 203.

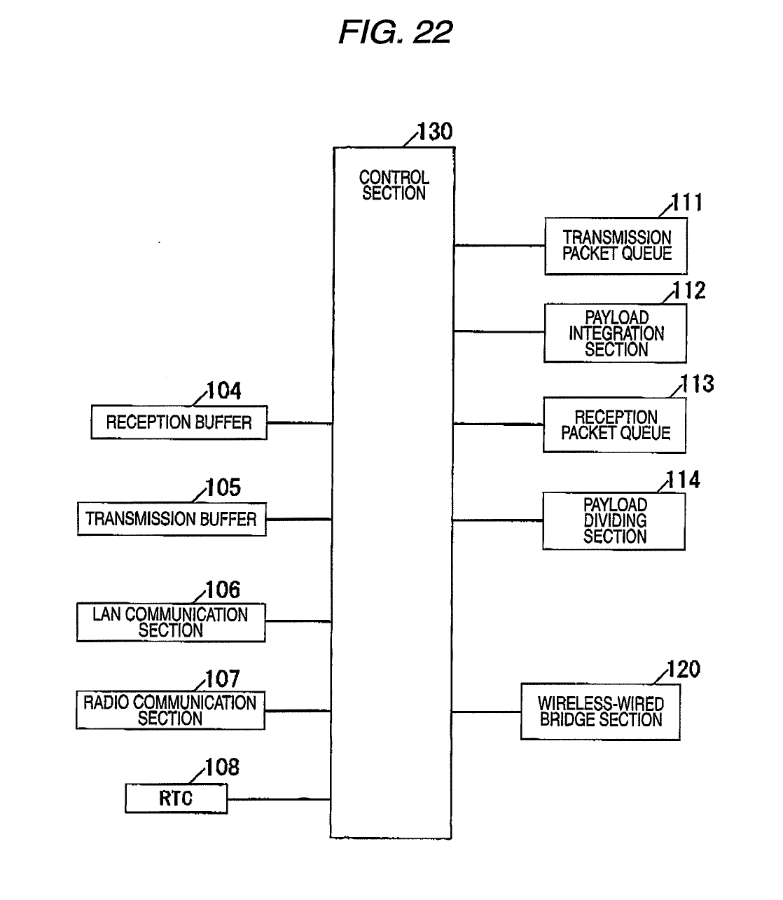

FIG. 22 is a functional block diagram showing a master unit in the second embodiment of the present invention.

In FIG. 22, reference numeral 104 is a reception buffer for accumulating data extracted from a received radio frame, 105 is a transmission buffer for accumulating radio transmission data, 106 is a LAN communication section for connecting with a wired network, and 107 is a radio communication section for radio framing and transmitting the data accumulated in the transmission buffer 105 and receiving a radio frame to store frame content in the reception buffer 104.

Reference numeral 108 is an RTC for measuring a time lapse, 111 is a transmission packet queue for storing an Ethernet (registered trademark) frame from a LAN side determined to be relayed in the FIFO manner along with a transmission request time such that a wired-wireless bridge section 120 described below radio frames and transmits it, and 112 is a payload integration section for integrating a voice packet input to the transmission packet queue 111 within a transmission standby time into one radio frame and writing it to the transmission buffer.

Reference numeral 113 is a reception packet queue for disassembling data received as a radio frame into packets and storing the packets in the FIFO manner, and 114 is a payload dividing section for determining whether or not content stored in the reception buffer 104 is originally intended for one packet, and writing the content to the reception packet queue 113 in the FIFO manner by disassembling it into a plurality of voice packets when the plurality of voice packets are integrated.

Reference numeral 120 is the wired-wireless bridge section for relaying a frame between wired and wireless if needed and destroying the frame otherwise, and 130 is a control section for the overall control.

The correspondence relationship between the configuration of FIG. 22 and the configuration of FIG. 4 will be described.

The reception buffer 104, the transmission buffer 105, the transmission packet queue 111, and the reception packet queue 113 are realized by a RAM 203.

The radio communication section 107 is realized by the baseband 205 and the RF 206, the RTC 108 is realized by an RTC 204, and the LAN communication section 106 is realized by a network I/F 213.

The payload integration section 112, the payload dividing section 114, the wired-wireless bridge section 120, and the control section 130 are realized when a CPU 201 executes a program stored in a ROM 202 while referring to data stored in the ROM 202 or referring to or changing data stored in the RAM 203.

Since the overall configuration of the wireless LAN telephone system and the operation outline of the master unit and the slave unit are not different from those of the first embodiment, a description is omitted.

First, the operation of the slave unit will be described.

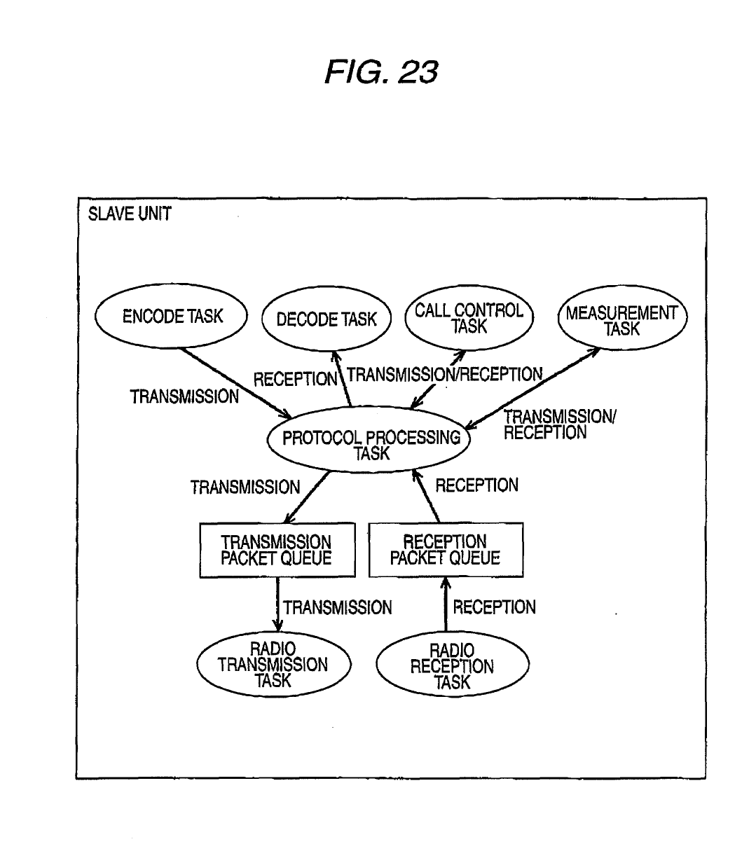

FIG. 23 shows a task configuration of the slave unit. In comparison with FIG. 7, a measurement task is newly added. On the other hand, a task configuration of the master unit is the same as that of the first embodiment (FIG. 8).

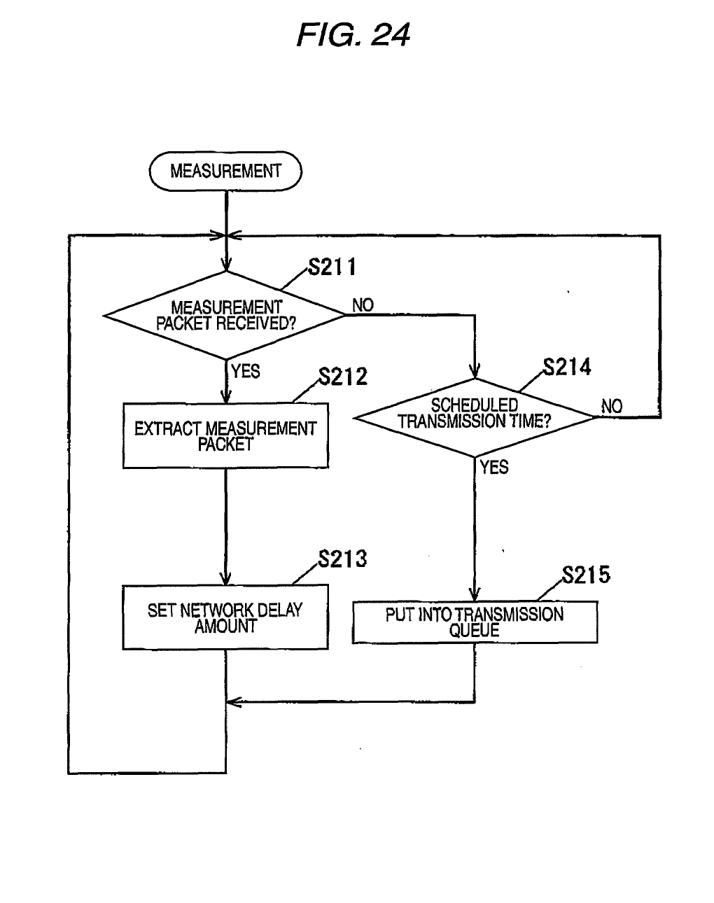

Next, an operation in tasks of the slave unit will be described. Since an encode task, a decode task, and a call control task among the tasks of the slave unit are the same as those of the first embodiment, a description is omitted. Here, the measurement task corresponding to a difference from the first embodiment will be described according to the flowchart of FIG. 24.

In this embodiment, it is assumed that the slave units for performing the telephone call are synchronized in advance with each other's RTC 108 in separate methods. A method for synchronizing each other's clock is generally a method using a GPS or a method using a protocol called NTP, but here a detailed description is not given.

Step S211

The network delay measurement section 121 determines whether or not a measurement packet arrives with reference to the reception packet queue 113. When the packet arrives, it proceeds to step S212. Otherwise, it proceeds to S214.

Step S212

The network delay measurement section 121 extracts a packet from the reception packet queue 113.

Step S213

The network delay measurement section 121 reads when the packet has been transmitted with reference to content of the extracted packet, and compares with a present time with reference to the RTC 108. Its result is written as a network delay amount to the parameter storage section 109. It proceeds to step S211. Here, it is assumed that the time written to the packet is 12:33 12.654 223. When the RTC 108 currently indicates 12:33 12.734 223, a time difference is 80 ms, and is written as the network delay amount to the parameter storage section 109. It proceeds to step S211.

Step S214

The network delay measurement section 121 determines whether or not a scheduled transmission time is reached with reference to the RTC 108. When the scheduled transmission time is reached, the next scheduled transmission time is set and step S215 is performed. Otherwise, it proceeds to step S211. Here, a measurement packet is transmitted once in 5 sec. Therefore, when a present value of the RTC 108 is 12:33 17.255 109, the scheduled transmission time is 12:33 22.255 109 after 5 sec.

Step S215

The network delay measurement section 121 reads the present time 12:33 17.255 109 with reference to the RTC 108, and puts it as packet content into the transmission packet queue 111. It proceeds to step S211.

In this way, the slave units measure the network delay amount by mutually exchanging the measurement packet and determine “how many packets are merged into one radio frame” in a radio transmission task on the basis thereof (details will be described below). Thereby, since a voice packet can be redundant within a range of a voice delay allowance time even when a network delay amount is varied due to fluctuation in network traffic, a stable telephone call can be secured.

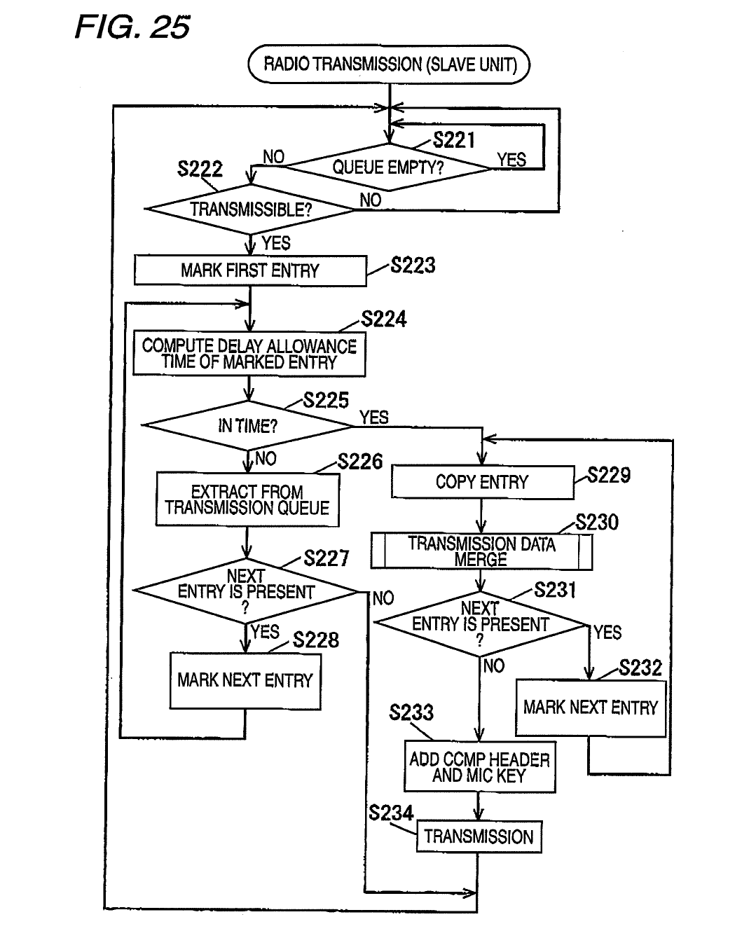

FIG. 25 is a flowchart of a radio transmission task in the second embodiment of the present invention. The transmission packet queue 111 is present for every destination MAC address, and the radio transmission task performs the following process for every transmission packet queue 111. In this regard, in the following description, the operation will be described by observing one transmission packet queue 111.

Steps S221 to S223

The same process as that of steps S131 to S133 of FIG. 13 in the first embodiment is performed.

Step S224

In relation to a marked entry, the control section 130 requests the transmission standby allowance time computation section 115 to compute a transmission standby allowance time. Then, the transmission standby allowance time computation section 115 computes a delay allowance time with reference to the parameter storage section 109, the RTC 108, and a stored reception request reception time mapped to the entry. First, a transmission standby time (about how much time has elapsed after the reception of the transmission request) is computed from the RTC 108 and the reception request reception time of the marked entry. Here, the following values are assumed.

RTC=12:33 22.043 994

Transmission Request Reception Time=12:33 22.008 876

Thus, Transmission Standby Time=RTC−Transmission Request Reception Time=35 ms.

Furthermore, it is assumed that the following values,

Codec Cycle=10 ms,

Codec Delay=1 ms,

Network Delay=80 ms,

Codec Standby Time=10 ms, and

Total Delay Allowance Time=120 ms,

are stored in advance in the parameter storage section 109. The codec delay is a time until a voice is input and A/D converted and data encoded according to a designated algorithm is output (wherein it is assumed that μ side PCM 8 kHz 8-bit sampling is designated), and a voice frame can be generated for the first time by gathering the data of which amount corresponds to the codec cycle. A delay time until the voice frame is decoded, D/A converted, and output as a voice is also the same value. This delay time may be asymmetrical according to a codec algorithm, but here will be continuously described as symmetrical. The codec standby time is a time for preventing the voice from being interrupted even when a voice packet arrival is varied by providing a jitter buffer at a receiving side and temporarily storing a voice packet waiting to be decoded. It is assumed that the network delay is periodically updated according to the above-described measurement task. The transmission standby allowance time is computed by the above values and the following expression.

Transmission Standby Allowance Time=Total Delay Allowance Time−Codec Cycle−Codec Delay×2−Network Delay−Codec Standby Time−Transmission Standby Time

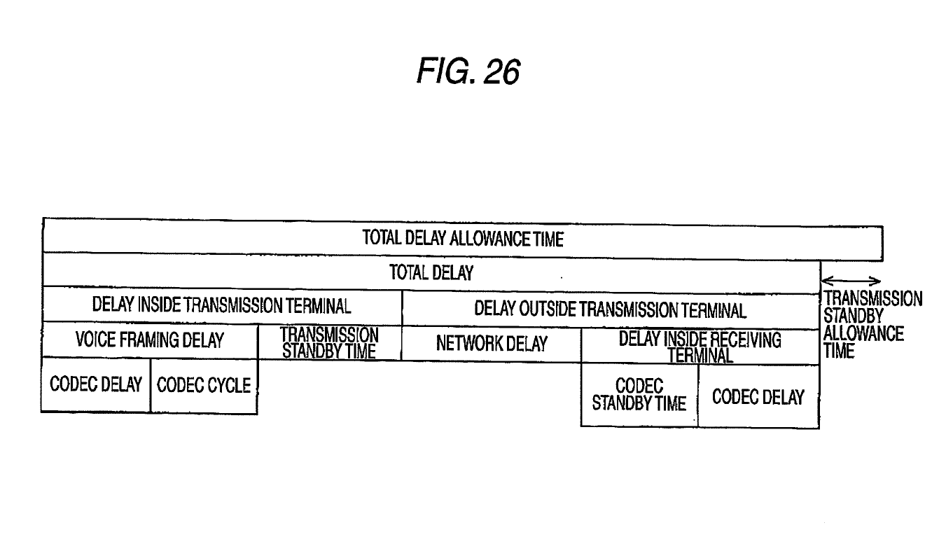

FIG. 26 shows the above expression such that it can be easily understood.

From the above expression, the transmission standby allowance time of the marked entry is set to −17 ms. If a value is negative, it means that a voice does not arrive within the allowance time even when a transmission is performed from the present moment.

The transmission standby allowance time computation section 115 notifies the control section 130 that “the transmission standby allowance time is −17 ms.”

Step S225

When the transmission standby allowance time received by the control section 130 from the transmission standby allowance time computation section 115 represents a negative value, that is, the transmission from the present moment is not made in time, it proceeds to step S226. Otherwise, it proceeds to step S229. Here, it proceeds to step S226 since the negative value is shown.

Step S226

The control section 130 extracts data of a marked entry from the transmission packet queue 111.

In the above example, the marked entry is destroyed because of the determination that the transmission from the present moment is not made in time.

Step S227

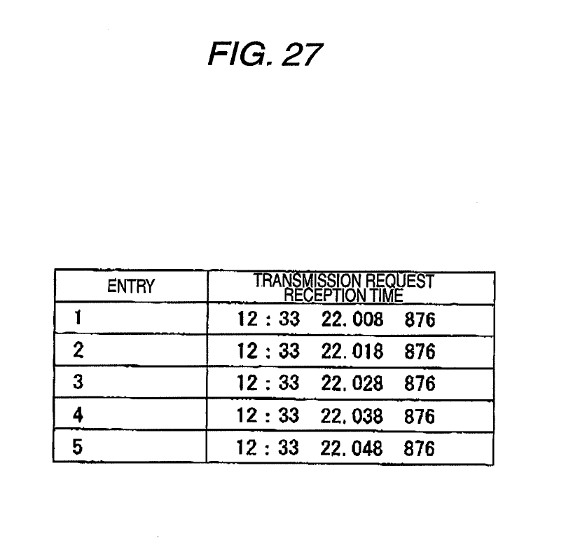

The control section 130 determines whether or not there is the next entry to the marked entry with reference to the transmission packet queue 111. If so, it proceeds to step S227. Otherwise, it proceeds to step S221. Here, it will be continuously described that there is the entry as shown in FIG. 27.

Step S228

The control section 130 marks the next entry. It proceeds to step S224.

As described above, a process of steps S224 to S228 is repeated and a voice packet which does not arrive at the other party within an allowance time is destroyed even when the transmission is made. In the example so far, entries 1 and 2 in FIG. 27 are destroyed.

Next, the case of determining that it arrives at the other party within the allowance time when the transmission is made from the present moment in step S225 will be described. It proceeds to step S229 since a determination is made that an entry 3 arrives within the allowance time.

Step S229

The control section 130 copies content of the marked entry. Here, the content of the entry 3 is temporarily stored by the control section 130.

Step S230

The control section 130 instructs the payload integration section 112 to merge data copied in step S229. Details will be described below. Data to be transmitted is written to the transmission buffer 105.

Step S231

The control section 130 determines whether or not there is the next entry to the marked entry with reference to the transmission packet queue 111. If so, it proceeds to step S232. Otherwise, it proceeds to step S233.

Steps S229 to S232 are repeated and entry content of the transmission packet queue is merged until there is no entry.

Step S232

The control section 130 marks the next entry. It proceeds to step S229.

Step S233

Since there is no entry to be merged in the transmission packet queue 111 after data of up to an entry 5 is merged, step S233 is executed.

Here, it is assumed that a radio frame is encrypted by an encryption system defined in IEEE 802.11i. The control section 130 instructs the radio communication section 107 to add a CCMP header and an MIC key. Then, the radio communication section 107 computes the CCMP header and the MIC key according to an encryption algorithm and adds them to payload positions defined in IEEE 802.11i of the transmission buffer 105.

Step S234

The control section 130 instructs the radio communication section 107 to transmit content of the transmission buffer 105. Then, the radio communication section 107 sends the instructed content as a radio frame into the air. It proceeds to step S221.

Here, it is assumed that a preamble or FCS defined in IEEE 802.11 is added in the radio communication section 107.

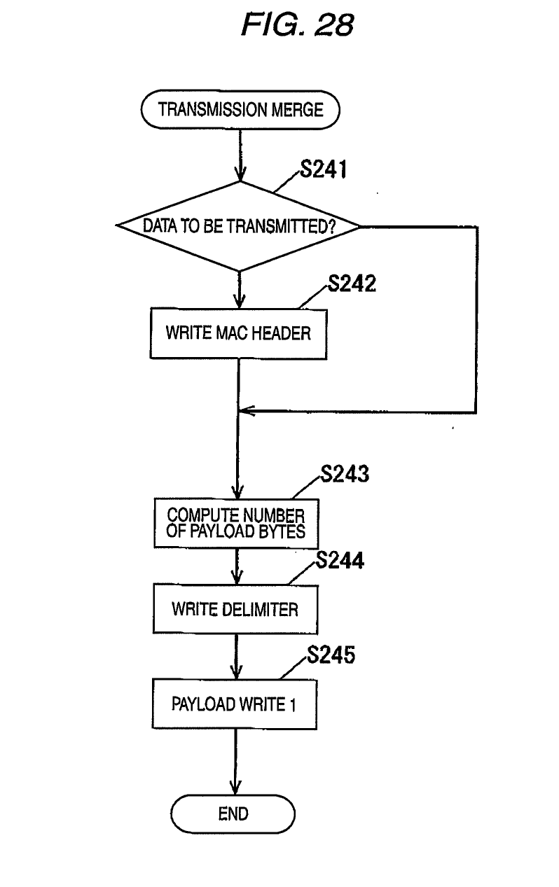

Next, a data merge process will be described according to the flowchart of FIG. 28. In this embodiment as compared with the first embodiment, a higher protocol analysis process is not performed and a payload is simply merged into one radio frame.

Step S241

The payload integration section 112 determines whether or not data is written to the transmission buffer 105. When the write is made, it proceeds to step S244. Otherwise, it proceeds to step S242.

Step S242

The payload integration section 112 writes a MAC header to the transmission buffer 105. It proceeds to step S244.

Step S243

The payload integration section 112 computes the total number of bytes of a received voice packet. Here, LLC Header (8 bytes)+IPv6 Header (40 bytes)+UDP Header (8 bytes)+RTP Header (12 bytes)+Voice (80 bytes)=148 bytes.

Step S244

The payload integration section 112 writes the total number of bytes obtained in step S243 as a payload delimiter to the transmission buffer 105. Here, a value of 148 is written.

Step S245

The payload integration section 112 writes the data received as the voice packet to the transmission buffer 105. The merge process ends.

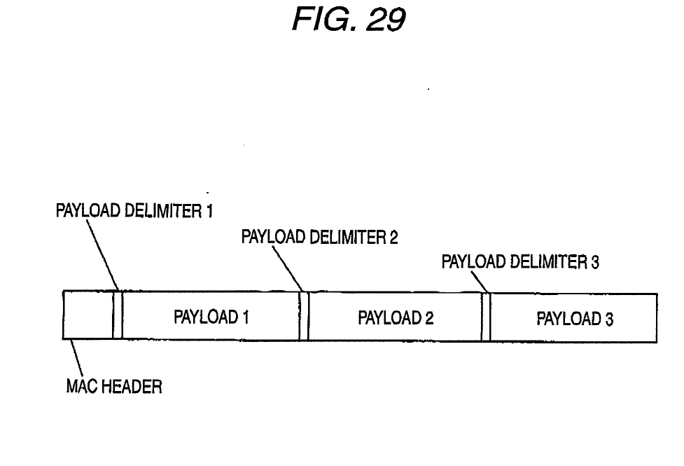

An aspect of the transmission buffer 105 written as described above is shown in FIG. 29. In the example so far, the entries 3 to 5 in FIG. 27 is written as payloads 1 to 3.

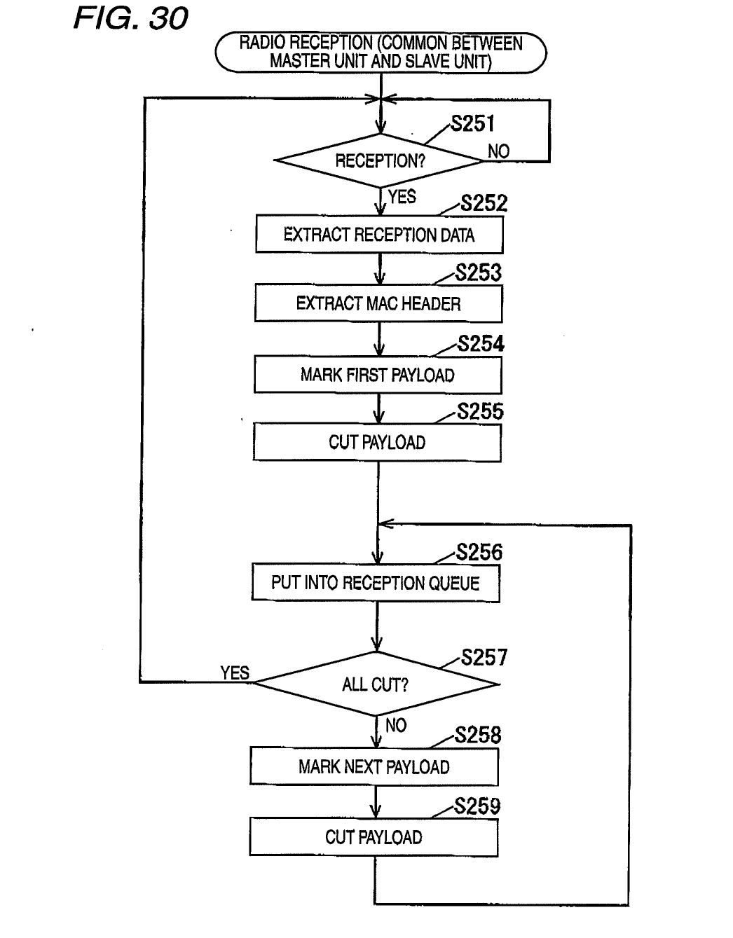

Next, the operation of the radio reception task will be described according to the flowchart of FIG. 30.

In the radio reception task in this embodiment, both the slave unit and the master unit perform the same process. Here, it is assumed that a radio frame destined for a local station is received by the radio communication section 107, and frame content is written as data to the reception buffer 104.

Steps S251˜S254

These are the same as steps S171 to S174 of FIG. 17 in the first embodiment.

Step S255

The payload dividing section 114 analyzes the first one byte as the delimiter, reads a value, obtains the number of payload bytes, and extracts a subsequent payload. It proceeds to step S257.

Steps S256 to S259

These are the same as steps S177 to 5180 of FIG. 17 in the first embodiment.

According to the above process, even when a plurality of voice packets are originally merged into one radio frame, it is correctly divided into voice packets and is passed to the protocol processing section 117. The decode task completes a decode process within a defined delay time and reproduces a voice.

The next is about the master unit, but a task configuration of the master unit is the same as that of the first embodiment, and the bridge task is the same as that of the first embodiment. Since the radio reception task is the same as that of the second embodiment, a description is omitted. Here, only the radio transmission task of the master unit will be described.

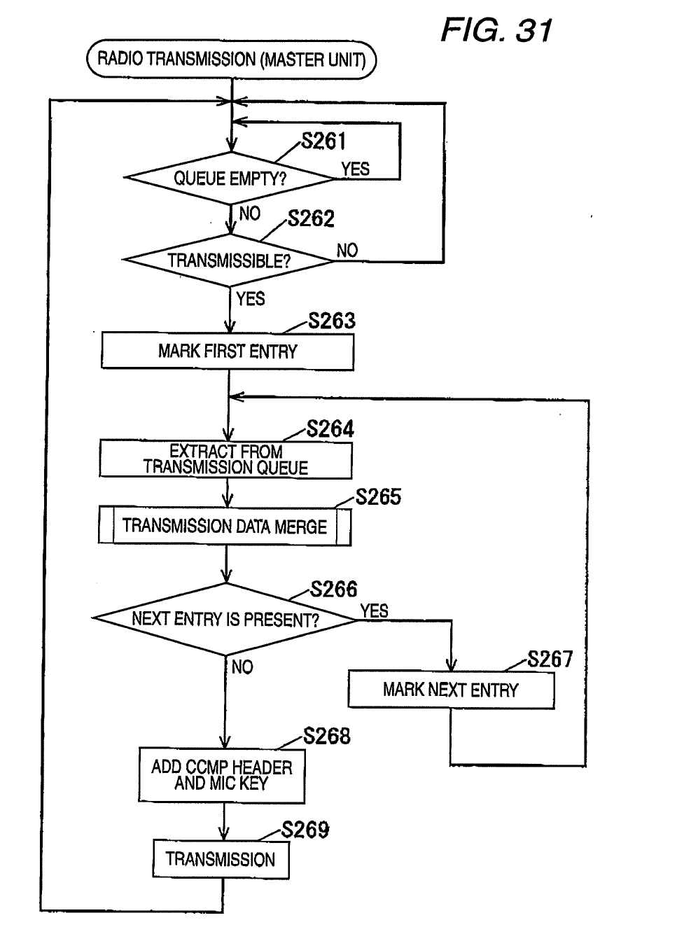

The radio transmission task of the master unit in this embodiment will be described according to the flowchart of FIG. 31.

Steps S261 to S262

The same process as that of steps S221 to S222 of FIG. 25 in the slave unit is performed.

Steps S263

The same process as step S223 of FIG. 25 in the slave unit is performed. It proceeds to step S264.

Step S264

The same process as step S226 of FIG. 25 in the slave unit is performed. It proceeds to step S265.

Steps S265 to S269

The same process as that of steps S230 to S233 of FIG. 25 in the slave unit is performed.

Step S269

The same process as step S234 of FIG. 25 in the slave unit is performed. It proceeds to step S261.

When the slave unit and the master unit as described so far are combined to be used, the high telephone call quality can be provided since a sound is not interrupted even though an error occurs while a voice delay during a telephone call is suppressed in a practical range.

As described above, a retransmission is conventionally inevitable due to error occurrence and a delay is accumulated, thereby resulting in the overflow of a jitter buffer in a reception terminal side and leading to the quality degradation of voice interruption or the like, but the same voice packets are transmitted in separate frames by the above-mentioned configuration according to this embodiment, such that the number of retransmissions can be reduced and a high-quality telephone call having a small delay is possible since the same packet is included in the other frame even when an error occurs in one packet.

Since the voice packets are merged and transmitted in one radio frame, a bandwidth is not unnecessarily pressed. Even when network traffic is varied, the network delay time can be measured and the transmission timing and the packet overlap amount per frame can be adapted. Thereby, a high-quality telephone call environment can be provided to a person using the wireless LAN telephone and a good communication environment can be provided to a user for performing data communication within the same wireless LAN without unnecessarily pressing the band.

### Third Embodiment

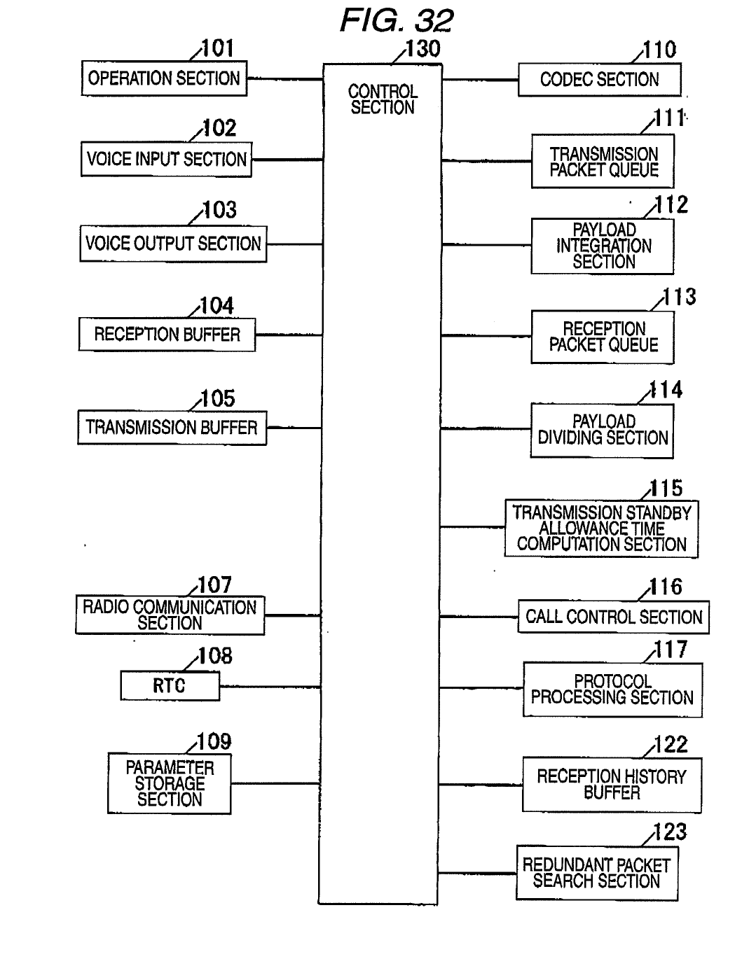

FIG. 32 is a functional block diagram showing a slave unit in a third embodiment of the present invention.

In FIG. 32, reference numeral 101 is an operation section for designating an outgoing call destination and making a telephone call instruction at the time of an incoming call and a call end instruction, 102 is a voice input section for inputting a voice, 103 is a voice output section for outputting a voice, 104 is a reception buffer for accumulating data extracted from a received radio frame, and 105 is a transmission buffer for accumulating radio transmission data.

Reference numeral 107 is a radio communication section for radio framing and transmitting the data accumulated in the transmission buffer 105 and receiving a radio frame to store frame content in the reception buffer 104, 108 is an RTC for measuring a time lapse, and 109 is a parameter storage section for storing a voice delay allowance time, a voice codec cycle, a voice codes delay, and a preset network delay amount.

Reference numeral 110 is a codec section for AND converting a voice input from the voice input section 102 to convert (encode) it into a voice packet using a predetermined algorithm, and D/A converting voice data after decoding using the predetermined algorithm to output it to the voice output section 103, and 111 is a transmission packet queue for storing the voice packet encoded by the codec section 110 in a FIFO manner along with a time when encoding is completed, that is, a transmission request reception time.

Reference numeral 112 is a payload integration section for merging a voice packet input to the transmission packet queue 111 within a transmission standby time into one radio frame and writing it to the transmission buffer, and 113 is a reception packet queue for disassembling data received as a radio frame into packets and storing the packets in the FIFO manner.

Reference numeral 114 is a payload dividing section for determining whether or not content stored in the reception buffer 104 is originally intended for one packet, and writing the content to the reception packet queue 113 in the FIFO manner by disassembling it into a plurality of voice packets when the plurality of voice packets are integrated, and 115 is a transmission standby allowance time computation section for referring to the voice delay allowance time, the voice codec cycle, the voice codec delay, and the preset network delay amount stored in the parameter storage section 109, comparing a value of the RTC 108 with a transmission request reception time, and computing an allowance time of transmission standby.

Reference numeral 116 is a call control section for outputting a dial tone, a busy tone, a ringer, or a ringback tone to the voice output section 103 according to an outgoing call, an incoming call, call connection/disconnection control, and each call state, and 117 is a protocol processing section for processing a call setup or release and a voice packet transmission/reception at the time of a telephone call according to a designated protocol.

Reference numeral 122 is a reception history buffer for storing contents or identifiers of a preset number of voice packets in the FIFO manner, 123 is a redundant packet search section for retrieving whether or not a voice packet equal to a designated voice packet is stored with reference to the reception history buffer 122, and 130 is a control section for the overall control.

Here, the correspondence relationship between the configuration of FIG. 32 and the configuration of FIG. 2 will be described.

The operation section 101 is realized by a keyboard 211, the voice input section 102 is realized by a microphone 208, and the voice output section 103 is realized by a loudspeaker 210.

The reception buffer 104, the transmission buffer 105, the parameter storage section 109, the transmission packet queue 111, the reception packet queue 113, and the reception history buffer 122 are realized by a RAM 203.

The radio communication section 107 is realized by a baseband 205 and an RF 206, the RTC 108 is realized by an RTC 204, and the codec section 110 is realized by the codec 212, an A/D 207, and a D/A 209.

The payload integration section 112, the payload dividing section 114, the transmission standby allowance time computation section 115, the redundant packet search section 123, and the control section 130 are realized when a CPU 201 executes a program stored in a ROM 202 while referring to data stored in the ROM 202 or referring to or changing data stored in the RAM 203.

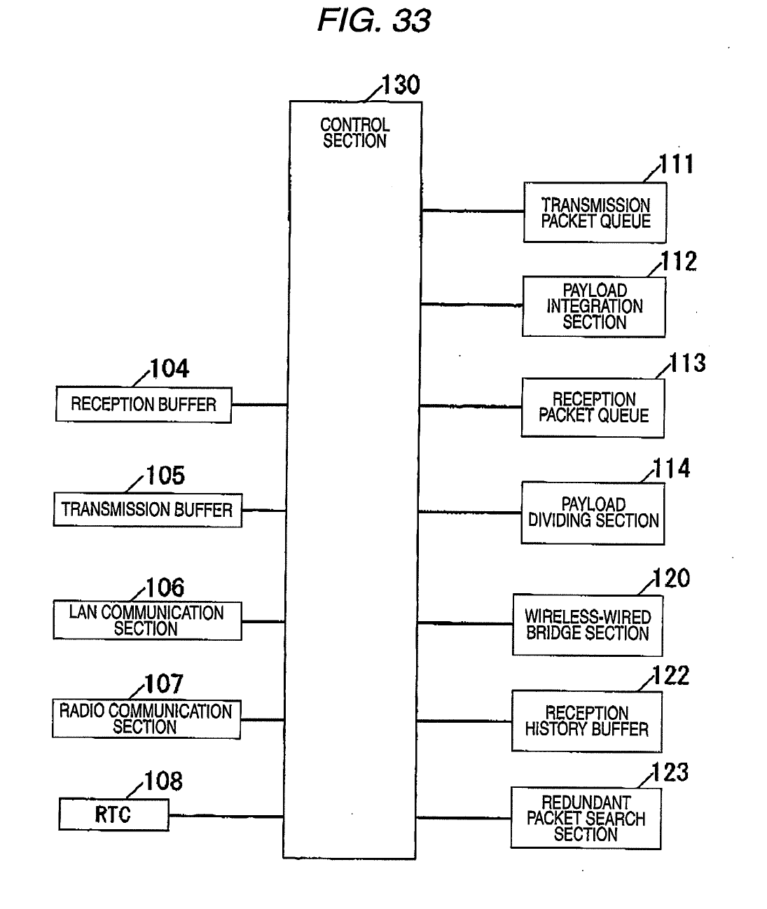

FIG. 33 is a functional block diagram of the master unit in the third embodiment of the present invention.

In FIG. 33, reference numeral 104 is a reception buffer for accumulating data extracted from a received radio frame, 105 is a transmission buffer for accumulating radio transmission data, and 106 is a LAN communication section for connecting with a wired network.

Reference numeral 107 is a radio communication section for radio framing and transmitting the data accumulated in the transmission buffer 105 and receiving a radio frame to store frame content in the reception buffer 104, 108 is an RTC for measuring a time lapse, and 111 is a transmission packet queue for storing an Ethernet (registered trademark) frame from a LAN side determined to be relayed in the FIFO manner along with a transmission request time such that a wired-wireless bridge section 120 described below radio frames and transmits it.

Reference numeral 112 is a payload integration section for integrating a voice packet input to the transmission packet queue 111 within a transmission standby time into one radio frame and writing it to the transmission buffer, 113 is a reception packet queue for disassembling data received as a radio frame into packets and storing the packets in the FIFO manner, and 114 is a payload dividing section for determining whether or not content stored in the reception buffer 104 is originally intended for one packet, and writing the content to the reception packet queue 113 in the FIFO manner by disassembling it into a plurality of voice packets when the plurality of voice packets are integrated.

Reference numeral 120 is a wired-wireless bridge section for relaying a frame between wired and wireless if needed and destroying the frame otherwise, 122 is a reception history buffer for storing contents or identifiers of a preset number of voice packets in the FIFO manner, 123 is a redundant packet search section for retrieving whether or not a voice packet equal to a designated voice packet is stored with reference to the reception history buffer 122, and 130 is a control section for the overall control.

Here, the correspondence relationship between the configuration of FIG. 33 and the configuration of FIG. 4 will be described.

The reception buffer 104, the transmission buffer 105, the transmission packet queue 111, the reception packet queue 113, and the reception history buffer 122 are realized by the RAM 203.

The radio communication section 107 is realized by the baseband 205 and the RF 206, the RTC 108 is realized by the RTC 204, and the LAN communication section 106 is realized by a network I/F 213.

The payload integration section 112, the payload dividing section 114, the wired-wireless bridge section 120, the redundant packet search section 123, and the control section 130 are realized when the CPU 201 executes a program stored in the ROM 202 while referring to data stored in the ROM 202 or referring to or changing data stored in the RAM 203.

Since the overall configuration of the wireless LAN telephone system and the operation outline of the master unit and the slave unit in this embodiment are not different from those of the first embodiment, a description is omitted. Similarly, since the task configurations of the master unit and the slave unit are also the same as those of the first embodiment, a description is omitted.

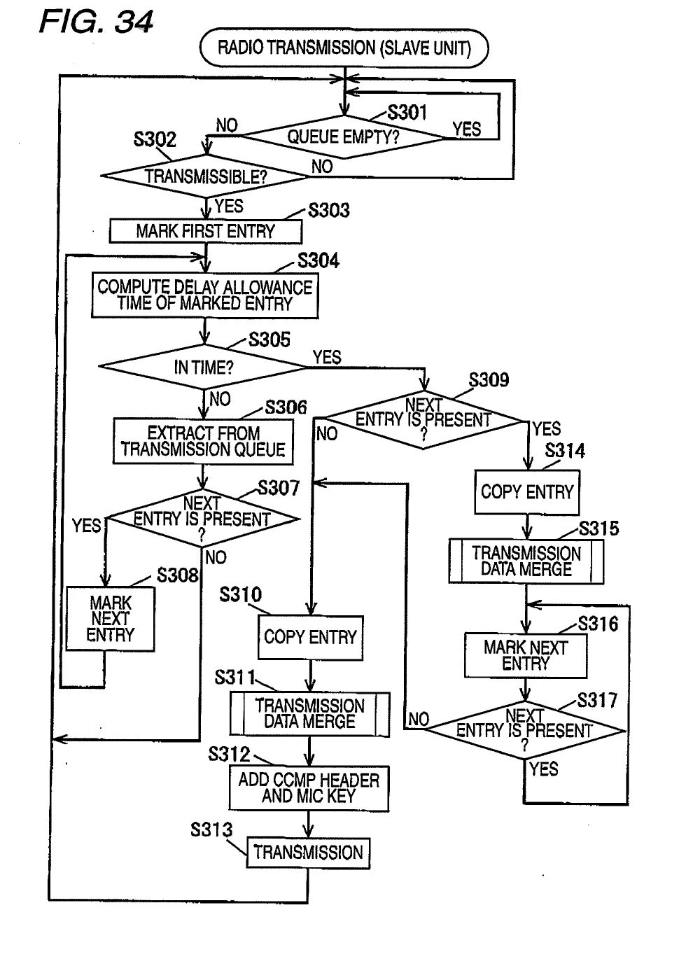

FIG. 34 is a flowchart of a radio transmission task of the slave unit in this embodiment.

The transmission packet queue 111 is present for every destination MAC address, and the radio transmission task performs the following process for every transmission packet queue 111. In this regard, in the following description, the operation will be described by observing one transmission packet queue 111. This embodiment is similar to the second embodiment, but there is a difference in that all packets capable of being transmitted within an allowance time are merged and transmitted in the second embodiment, whereas only an oldest packet and a newest packet among packets capable of being transmitted within the allowance time are merged in this embodiment. Hereinafter, a description is given in detail by paying attention to this point.

Steps S301 to S308

The same process as that of steps S221 to S228 of FIG. 25 in the second embodiment will be performed.

In the process so far, a voice packet which does not arrive at the other party within an allowance time is deleted from the transmission packet queue 111 even when the transmission is made from the present moment.

Step S309

The control section 130 determines whether or not there is the next entry to a marked entry with reference to the transmission packet queue 111. If so, it proceeds to step S314. Otherwise, it proceeds to step S310. Here, it will be continuously described that there is no entry. In this case, only one voice packet remains in the transmission packet queue 111.

Step S310

The control section 130 copies content of the marked entry.

Step S311

The control section 130 instructs the payload integration section 112 to merge data copied in step S310. Details will be described below. Data to be transmitted is written to the transmission buffer 105.

Step S312

Here, it is assumed that a radio frame is encrypted by an encryption system defined in IEEE 802.111. The control section 130 instructs the radio communication section 107 to add a CCMP header and an MIC key. Then, the radio communication section 107 computes the CCMP header and the MIC key according to an encryption algorithm and adds them to payload positions defined in IEEE 802.11i of the transmission buffer 105.

Step S313

The control section 130 instructs the radio communication section 107 to transmit content of the transmission buffer 105. Then, the radio communication section 107 sends the instructed content as a radio frame into the air. Here, it is assumed that a preamble or FCS defined in IEEE 802.11 is added in the radio communication section 107.

It proceeds to step S301.

Next, the case where there is the next entry in step S309 will be described.

It is assumed that five entries are registered in the transmission packet queue 111 as shown in FIG. 27. In the process of up to step S309, entries 1 and 2 are destroyed since they do not arrive within an allowance time even though the transmission is made from the present moment. That is, a present entry 3 is marked. Since an entry 4 is present in the transmission packet queue 111, step S314 is executed.

Step S314

The same process as step S310 is performed.

Step S315

The same process as step S311 is performed.

Step S316

The same process as step S308 is performed.

Step S317

The same process as step S309 is performed. When the next entry is present, it proceeds to step S316. Otherwise, it proceeds to step S310.

As described above, an oldest voice packet is merged as transmission data in the process of steps S314 and S315. A newest packet in the transmission packet queue 111 is found by steps S316 and S317.

Thereafter, the oldest packet and the newest packet are merged and transmitted by the process of steps S310 to S313. In this embodiment, it is assumed that the same merge process as that of the second embodiment is performed.

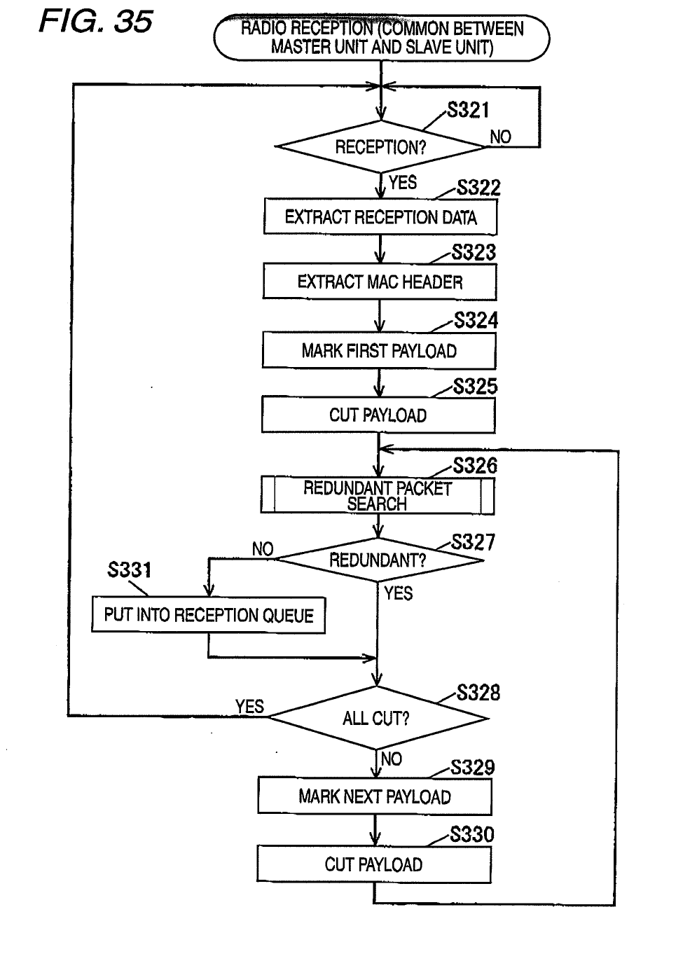

Next, the operation of the radio reception task will be described according to the flowchart of FIG. 35.

In the radio reception task in this embodiment, both the slave unit and the master unit perform the same process. Here, it is assumed that a radio frame destined for a local station is received by the radio communication section 107, and frame content is written as data to the reception buffer 104.

Steps S321 to S325

The same process as that of steps S251 to S255 of FIG. 30 in the second embodiment is performed.

Step S326

The payload dividing section 114 asks the redundant packet search section 123 whether or not a packet of content equal to a payload currently being marked is already registered in the reception history buffer 122.

Step S327

The redundant packet search section 123 notifies the control section 130 of a result of step S326. Details of this process will be described below. If the registration is made, it proceeds to step S328. Otherwise, it proceeds to step S331.

Step S328 to S329

The same process as that of steps S257 to S258 of FIG. 30 in the second embodiment is performed.

Step S330

The same process as step S259 of FIG. 30 in the second embodiment is performed. It proceeds to step S326.

Step S331

The payload dividing section 114 puts an obtained payload into the reception packet queue 113. It proceeds to step S328.

According to the above process, even when a plurality of original voice packets are merged into one radio frame, it is correctly divided into voice packets and is passed to the protocol processing section 117. Even when the same voice packet is copied at a transmitting side and is transmitted in different radio frame, the same voice packet is destroyed in this process. Thereby, the master unit prevents the same voice packet to flow into the LAN, such that network traffic does not unnecessarily increases.

Next, the aforementioned redundant packet search process will be described in detail.

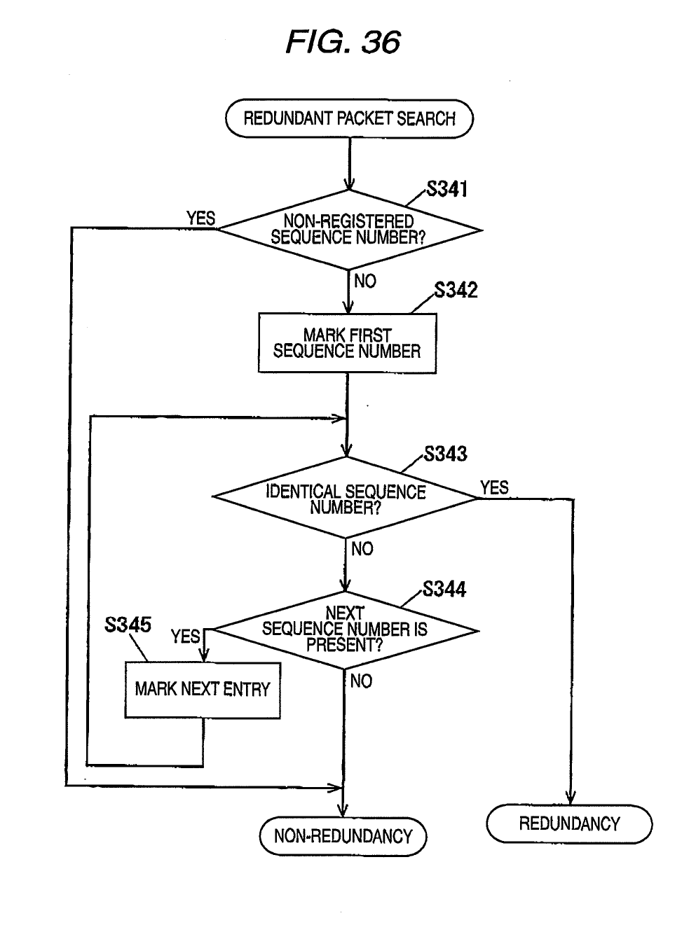

FIG. 36 is a flowchart showing the redundant packet search process in this embodiment.

Here, it is assumed that a voice packet is transmitted by an RTP protocol. In the RTP protocol, a sequence number is written to a header part and a packet redundancy or missing, a sequence change, or the like can be detected. Here, it is assumed that the reception history buffer 122 stores 10 sequence numbers in the FIFO manner.

Step S341

The redundant packet search section 123 determines whether or not a sequence number is registered within the reception history buffer 122. When any one is not registered, a process as “non-redundancy” ends. Otherwise, it proceeds to step S342.

Step S342

The redundant packet search section 123 marks a first sequence number stored in the FIFO manner within the reception history buffer 122.

Step S343

The redundant packet search section 123 refers to a sequence number present in a header part of an RTP packet included in a payload designated by the payload dividing section 114 and checks whether or not it is the same as a sequence number currently being markd. When they are identical, the process as “non-redundancy” ends. Otherwise, it proceeds to step S344.

Step S344

The redundant packet search section 123 determines whether or not the next sequence number to the sequence number currently being markd is stored within the reception history buffer 122. When storing is done, it proceeds to step S345. Otherwise, the process as “non-redundancys” ends.

Step S345

The redundant packet search section 123 moves to the next sequence number to the sequence number currently being markd that is stored in the FIFO matter in the reception history buffer 122. It proceeds to step S343.

In this embodiment according to the above process, a sequence number of an RTP header of a received voice packet is examined over 10 previous packets and determines whether or not it has already been received. Thereby, the already received packet is destroyed by the process of the payload integration section 114 since it is processed as “redundancy.”

The next is about the master unit, but the task configuration of the master unit is the same as that of the first embodiment. Here, only a radio transmission task of the master unit different from those of the embodiments 1 and 2 will be described.

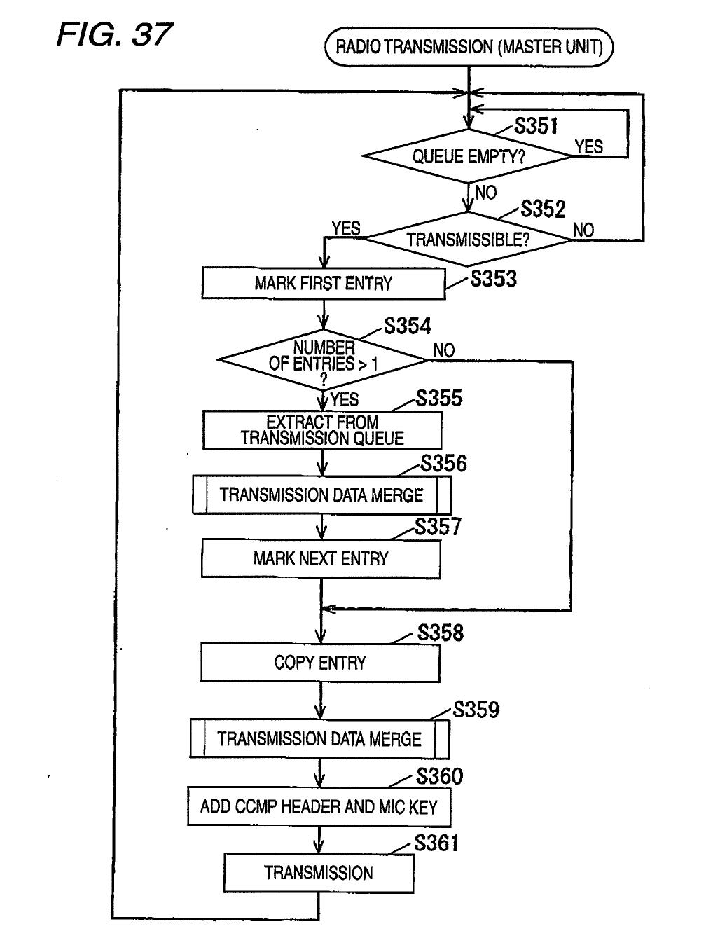

The radio transmission task of the master unit in this embodiment will be described according to the flowchart of FIG. 37.

Steps S351 to S352

The same process as that of steps S131 to S132 of FIG. 13 in the first embodiment is performed.

Step S353

The same process as step S133 of FIG. 13 in the first embodiment is performed. It proceeds to step S354.

Step S354

The control section 130 determines whether or not the number of entries is larger than 1 with reference to the transmission packet queue 111. In the case of larger than 1, it proceeds to step S355. Otherwise, it proceeds to step S358.

Steps S355 to S361

The same process as that of steps S136 to S142 of FIG. 13 in the first embodiment is performed. It proceeds to step S351.

When the slave unit and the master unit shown in this embodiment are combined to be used as described so far, the loss of a voice packet does not occur even when a continuous radio frame has a communication error due to the occurrence of a burst error often occurring in the wireless LAN. For example, when voice packets 1 and 3 are merged and transmitted in a radio frame A, voice packets 2 and 4 are merged and transmitted in a radio frame B, voice packet 3 and 5 are merged and transmitted in a radio frame C, voice packets 4 and 6 are merged and transmitted in a radio frame D, voice packet 5 and 7 are merged and transmitted in a radio frame E, and voice packets 6 and 8 are merged and transmitted in a radio frame F, the voice packets 3, 5, 4, and 6 contained in the radio frame C and the radio frame D are respectively included in the radio frame A, the radio frame E, the radio frame B, and the radio frame F even when the radio frames C and D are continuously missed due to a burst error, such that a receiving side can restore the original voice. It is different from the method shown in the second embodiment that a radio frame length is not unnecessarily lengthened since there is the form in which only two voice packet related to one frame are carried, and the influence to other terminals communicating with the same ch can be further reduced.

As described above, a retransmission is conventionally inevitable due to error occurrence and a delay is accumulated, thereby resulting in the overflow of a jitter buffer in a reception terminal side and leading to the quality degradation of voice interruption or the like, but the same voice packets are transmitted in separate frames by the above-mentioned configuration according to this embodiment, such that the number of retransmissions can be reduced and a high-quality telephone call having a small delay is possible since the same packet is included in the other frame even when an error occurs in one packet.

Since a plurality of voice packets are merged and transmitted in one radio frame, a bandwidth is not unnecessarily pressed. Even when a radio frame transmission and reception continuously fail due to a burst error, the loss of a voice packet can be avoided as much as possible by interleaving the voice packet. There is no worry that a network load is unnecessarily applied by destroying the same voice packet at the receiving side. Thereby, a high-quality telephone call environment can be provided to a person using the wireless LAN telephone and a good communication environment can be provided to a user for performing data communication within the same wireless LAN without unnecessarily pressing the band.

In this embodiment, two voice packets are transmitted as one radio frame, but three or more voice packets can be selected according to a preset algorithm and can be transmitted in one radio frame.

The first, second, and third embodiments have been described in the slave unit and the master unit of the wireless LAN telephone apparatus, but the present invention is not limited thereto. It is not limited to communication using the wireless LAN and is applicable to any communication apparatus for performing wireless or wired packet communication. Also a packet type is not limited to a voice packet, and can be a packet including any type of data.

Many modifications and variations of the present invention are possible in the light of the above techniques. It is therefore to be understood that within the scope of the invention the invention may be practiced than as specifically described.

The present application is based upon and claims the benefit of priority of Japanese Patent Application No. 2007-101534 filed on Apr. 9, 2007, the contents of which are incorporated herein by reference in its entirety.

What is claimed is:

1. A communication apparatus, comprising:
a storage section that stores a packet;
a copy section that creates one or more copies of the packet stored in the storage section; and
a transmission section that transmits at least two among the one or more copies and the packet in plural frames.

2. The communication apparatus according to claim 1, wherein the storage section stores a plurality of the packets; and
wherein the copy section creates copies of the packets stored in the storage section,
the communication apparatus further comprising: an integration section that forms a frame of the plurality of the packets using, for each of the packets, either the packet stored in the storage section or the copy of the packet created by the copy section, and
wherein the transmission section transmits the frame formed by the integration section.

3. The communication apparatus according to claim 2, wherein the copy section creates a copy of the second oldest packet among the packets stored in the storage section; and
wherein the integration section integrates the oldest packet among the packets stored in the storage section and the copy of the second oldest packet created by the copy section into the frame.

4. The communication apparatus according to claim 2, further comprising:
a computation section that computes a transmission standby allowance time representing a time until each packet stored in the storage section is allowed to be transmitted; and
a determination section that determines whether or not a transmission from a present moment is made in time, on the basis of the transmission standby allowance time computed by the computation section,
wherein the copy section creates copies of at least two packets among packets for which the transmission from the present moment has been determined to be in time by the determination section; and
wherein the integration section integrates the copies created by the copy section.

5. The communication apparatus according to claim 4, wherein the copy section creates copies of two or more discontinuous packets among the packets for which the transmission from the present moment has been determined to be in time by the determination section.

6. The communication apparatus according to claim 5, wherein the copy section creates copies of the oldest packet and the newest packet among the packets for which the transmission from the present moment has been determined to be in time by the determination section.

7. A slave unit of a wireless LAN telephone using the communication apparatus according to claim 1.

8. A master unit of a wireless LAN telephone using the communication apparatus according to claim 1.

9. A communication apparatus, comprising:
a storage section that stores a packet;
a copy section that creates one or more copies of the packet stored in the storage section; and
a transmission section that transmits, in one frame, one copy created by the copy section and transmits, in another frame, one among another copy created by the copy section and the packet stored in the storage section.

10. A slave unit of a wireless LAN telephone using the communication apparatus according to claim 9.

11. A master unit of a wireless LAN telephone using the communication apparatus according to claim 9.

12. A communication method, comprising:
storing a packet;
creating one or more copies of the stored packet; and
transmitting at least two among the created one or more copies and the stored packet in plural frames.

13. The communication method according to claim 12, wherein a plurality of the packets is stored, in the storing process; and
wherein copies of the plurality of packets stored in the storing process are created, in the creating process,
the communication method further comprising: forming a frame of the plurality of packets using, for each of the packets, either the stored packet or the created copy; and
wherein the formed frame is transmitted.

14. The communication method according to claim 13, wherein a copy of the second oldest packet among the stored packets is created; and
wherein the oldest packet among the stored packets and the created copy of the second old packet are integrated into the frame.

15. The communication method according claim 13, further comprising:
computing a transmission standby allowance time representing a time until each stored packet is allowed to be transmitted; and
determining whether or not a transmission from a present moment is made in time, on the basis of the computed transmission standby allowance time,
wherein copies of at least two packets among packets for which the transmission from the present moment has been determined to be in time are created; and
wherein the created copies are integrated.

16. The communication method according to claim 15, wherein copies of two or more discontinuous packets among the packets for which the transmission from the present moment has been determined to be in time are created.

17. The communication method according to claim 16, wherein copies of the oldest packet and the newest packet among the packets for which the transmission from the present moment has been determined to be in time are created.
